(19) United States
(12) Patent Application Publication
(10) Pub. No.: US 2017/0329933 A1
(43) Pub. Date: Nov. 16, 2017

(54) ADAPTIVE THERAPY AND HEALTH MONITORING USING PERSONAL ELECTRONIC DEVICES

(71) Applicants: Thomas Edwin Brust, White Bear Lake, MN (US); Tom Waddell, New Brighton, MN (US); Scott Nelson, Minneapolis, MN (US); Joseph Rueter, Minneapolis, MN (US)

(72) Inventors: Thomas Edwin Brust, White Bear Lake, MN (US); Tom Waddell, New Brighton, MN (US); Scott Nelson, Minneapolis, MN (US); Joseph Rueter, Minneapolis, MN (US)

(21) Appl. No.: 15/154,393

(22) Filed: May 13, 2016

(51) Int. Cl. G06F 19/00; G06F 17/30

(52) U.S. Cl. CPC G06F 19/3481; G06F 19/3418; G06F 17/30528; G06F 17/3056

(57) ABSTRACT

Systems and methods for implementing and performing therapy-based workflows to assist a human user with performing health therapy activities are described. In various examples, therapy workflows involving the use of wearable or other personal electronic devices are described, including the use of various graphical user interfaces for assisting users with the performance of therapy activities. In an example, a computing device may evaluate profile characteristics of a human user, evaluate wearable sensor data originating from a wearable device worn by the human user, and obtain content from a content suggestion engine to be output during the therapy session based on the profile characteristics and the wearable sensor data. In further examples, the suggested activity content may be transmitted, displayed, and output to the human user in a graphical user interface during the therapy session, based on a duration and tinning determined by the content suggestion engine.

### CROSS-REFERENCE TO RELATED APPLICATIONS

This application includes subject matter related to the following United States Patent Applications to Brust et al.: Ser. No. 13/772,405, titled “GOAL-BASED CONTENT SELECTION AND DELIVERY”, filed Feb. 21, 2013; Ser. No. 13/772,697, titled “CONTENT SUGGESTION ENGINE,” filed Feb. 21, 2013; Ser. No. 13/801,045, titled “EXPERT-BASED CONTENT AND COACHING PLATFORM,” filed Mar. 13, 2013; and Ser. No. 13/801,315. titled “METHODOLOGY FOR BUILDING ANT) TAGGING RELEVANT CONTENT,” and filed Mar. 13, 2013; the disclosure of each of the preceding patent applications are incorporated by reference herein in their entireties.

### TECHNICAL FIELD

Embodiments pertain to techniques and systems for processing data from electronic devices. Some embodiments relate to data workflows in information systems to select, suggest, recommend, deliver, render, and display content to particular human subjects based on collected data from electronic health monitoring and health activity devices.

### BACKGROUND

Therapy activities associated with medical treatment often involve a series of prescribed activities to promote rehabilitation after an injury or onset of a medical condition. For example, physical therapy or physiotherapy activities often involve a regimen of exercises and movements that are scheduled to be performed at certain intervals, such as a repetition of movement for the injured body area for a certain number of times per day. When a patient begins the medical treatment in a controlled setting (such as a doctor's office or rehabilitation center), compliance with the therapy regimen is closely monitored and feedback on the therapy activity techniques can be directly given to the patient. However, when a patient transitions to the performance of the therapy regimen in other settings, such as at home or with the assistance of untrained providers, the therapy activities are far less likely to be performed correctly, effectively, or safely.

Existing electronic devices and technologies do not fully address the underlying conditions and scenarios that are involved with therapy and rehabilitation activities. For example, some electronic coaching services only provide generic recommendations or selections of content, such as generic tips or guidelines of how to perform certain therapy exercises. Additionally, the collection of electronic therapy information outside of medical facility settings is limited, and feedback on how to perform therapy activities is often a manual, human-guided process. Accordingly, the type of information that is selected, delivered, and processed in existing content delivery systems often involves extensive human selection and revision of recommendations, and is often unusable or unhelpful in a therapy setting.

### BRIEF DESCRIPTION OF THE DRAWINGS

FIG. 1 illustrates an interaction diagram for electronic communications occurring among example information systems, devices, and users according to an example described herein.

FIG. 2 illustrates an information flow diagram for data communicated among users and information system elements according to an example described herein.

FIG. 3 illustrates therapist and patient user interfaces to a health information system according to an example described herein.

FIGS. 4A, 48, 4C, 4D, 4E, and 4F illustrate features of therapist and administration user interfaces to a health information system according to an example described herein.

FIGS. 5A, 58, 5C, and 5D illustrate features of a patient user interface to a health information system according to an example described herein.

FIGS. 6A, 6B, 6C, 6D, and 6E illustrate additional features of a patient user interface to a health information system with use of integrated sensor device according to an example described herein.

FIGS. 7A and 7B illustrate measurements of a range of motion obtained from physical therapy exercises that may be monitored and tracked with a wearable device and a health information system according to an example described herein.

FIG. 8 illustrates inputs and outputs of data processed in a health information system according to an example described herein.

FIGS. 9A and 9B illustrate flowcharts depicting operations for methods of therapy and health monitoring using a personal electronic device according to an example described herein.

FIG. 10 illustrates relationships between entities in therapy and health monitoring environments according to an example described herein.

FIG. 11 illustrates an example technique of user interactivity with therapy activity suggestions from a content suggestion engine operating within a health information system according to an example described herein.

FIG. 12 illustrates an example method of determining suggested content for therapy activities with a health information system according to an example described herein.

FIG. 13A illustrates a flowchart depicting operations for starting a therapy-based recommendation workflow according to an example described herein.

FIG. 13B illustrates a flowchart depicting operations for continuing a therapy-based recommendation workflow according to an example described herein.

FIG. 14 illustrates an example technique of delivering suggested actions to and obtaining feedback from a user in a therapy-based content workflow according to an example described herein.

FIG. 15 illustrates uses of member profile information and supporter coaching tools in connection with expert-based content selection and delivery techniques according to an example described herein.

FIG. 16 illustrates data operations occurring in the generation and use of expert-driven content playlists according to an example described herein.

FIG. 17 illustrates an example method implementing creation and delivery of content to one or more users from an expert or other coaching source in a therapy workflow according to an example described herein.

FIG. 18 illustrates an example technique of processing user interaction with suggested actions of a suggestion playlist in a therapy workflow according to an example described herein.

FIG. 19 illustrates an example method implementing a goal-based workflow for effecting therapy using an information system according to an example described herein.

FIG. 20 illustrates a flowchart depicting a workflow for user and supporter interaction in connection with a therapy supporter content service interface according to an example described herein.

FIG. 21 illustrates a flowchart of interaction between a user and a supporter in a therapy workflow according to an example described herein.

FIG. 22 illustrates an example system configuration of an information system arranged to provide therapy-based suggested content according to an example described herein.

FIG. 23 illustrates an example of a computer system to implement techniques and system configurations according to an example described herein.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The present disclosure illustrates various techniques and configurations to enable a series of worldlows for the selection, processing, delivery, and presentation of information for medical therapy, treatment, rehabilitation, intervention, care, and related assistance, advice, and coaching. As referred to herein, all variants of such activities are referred to collectively as “therapy”, which encompasses any number of medical, physiological, psychological, personal, or social activities to assist with the remediation, treatment, or improvement of some health condition.

The types of therapy discussed herein are provided with specific examples of physical therapy (physiotherapy) activities, such as may be coordinated or overseen by a physical therapist (physiotherapist) or occupational therapist. The physical therapy activities that are conducted as part of a physical therapy regimen may include various physical therapy interventions such as therapeutic exercises, manual therapy techniques, the use of exercise devices or electrotherapeutic modalities, and related consultation, evaluation, and examination of such interventions. The type of physical therapies that may be performed with the presently described techniques and systems may relate to an orthopedic or sports injury, chronic condition, progressing condition, or other physiological medical condition. Accordingly, it is intended that the techniques provided with specific reference to physical therapy treatment of an orthopedic injury, for example, would also he applicable to other settings such as surgical rehabilitation, pain management, and cardiovascular and pulmonary physiotherapy.

As discussed herein, a series of therapy workflows may be guided through the use of a health information system and electronic devices that collect and output data. These electronic devices may include wearable devices, sensors, and like specialized electromechanical components, and such electronic devices are collectively referred to as “personal electronic devices.” The therapy workflows may be exposed through a series of user interfaces that involve social aspects and communications, including predictive suggestions and dynamic feedback for encouraging the performance of therapy activities. Accordingly, described below are a variety of system configurations which explain the uses of the health information system and wearable (and non-wearable) personal electronic devices to such therapy workflows.

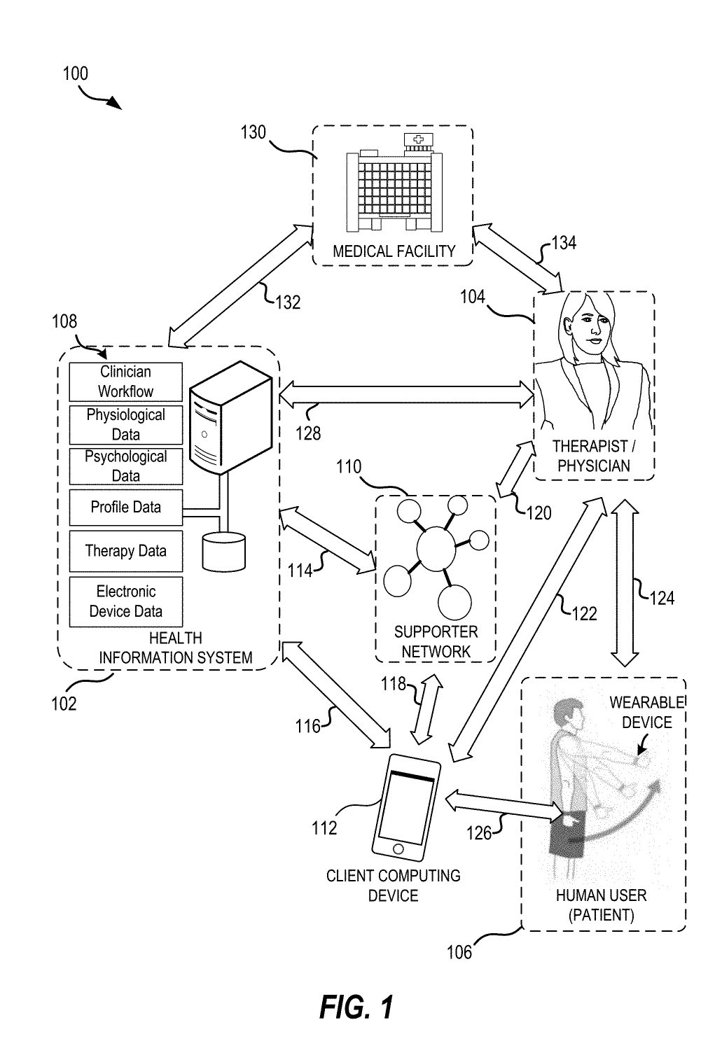

FIG. 1 illustrates an interaction diagram 100 for electronic communications 114, 116, 118, 120, 122, 124, 126, 128, 132, 134 occurring among example information systems, devices, and users according to a therapy workflow example described herein. These electronic communications explained in this illustration and throughout this disclosure may occur wirelessly, with wired connections, and over a variety of personal area, local area, and wide area (e.g., Internet) networks. Accordingly, the particular mode of communication can take a variety of forms, depending on the treatment scenario and the desired therapy workflow.

As shown, a health information system 102 enables management of a series of data values and data processes 108 for the treatment of a human user 106 (e.g., a client or patient). The managed data may include physiological data, psychological data, profile data (e.g., for a profile unique to the human user 106), therapy data, and electronic device data (e.g., data collected from a wearable device worn by the human user 106), each of which may integrate with a clinician workflow. The health information system 102 may operate as a cloud-based or server-based information system, which collects data on the human user 106 that is communicated from a client computing device 112, a supporter network 110, a therapist/physician 104, or a medical facility 130.

The role of the therapist/physician 104 in the therapy workflow is to provide an oversight of therapy activities being conducted by the human user 106. The therapist 104 may provide electronic communications 128 to the health information system 102 in the form of recommendations, an organized plan, guidance, or other definitions for therapy activities, which will later be communicated from the health information system 102 to the human user 106. The therapist/physician 104 may also provide electronic communications 124 to the personal electronic device of the human user 106 (e.g., via device programming or via device setting adjustments established by the therapist 104, communicated directly to the wearable device or indirectly to the wearable device through a service), or to the client computing device 112 of the human user 106 (e.g., via data provided from the therapist to an app of the client computing device 112, communicated directly to the client computing device 112 or indirectly to the client computing device 112 through a service), such as in the form of textual messages, programming settings, audiovisual content, indications, and other electronic communications in real-time.

The medical facility 130 in the therapy workflow may monitor therapy interactions occurring between the therapist 104 and the human user 106, and determine a status of the therapy activities for purposes of medical treatment. For example, the medical facility 130 may perform electronic communications 132 with the health information system 102 to receive or transmit medical information to define characteristics of therapy or assist the therapy interactions; the medical facility 130 may perform electronic communications 134 with the therapist 104 to inform the therapist 104 of the medical information or other characteristics useful with treatment. Further, the medical facility 130 may use the communications 132, 134 to monitor therapy interactions and collect data regarding treatment outcomes (such as, which therapist is successfully treating patient? Or, which clinic or type of treatment offers the best outcome?). The medical facility 130 may also utilize medical records systems and other types of health information systems to assist or monitor outcomes in the therapy workflow.

The role of the supporter network 110 in the therapy workflow is to provide encouragement, recommendations, and support of therapy activities being conducted by the human user 106. The supporter network 110 may perform this role through interaction with the health information system 102, as the health information system 102 provides suggestions to the supporter network 110 to be communicated to the client computing device 112. The supporter network 110 may also receive communication from the therapist/physician 104, to forward suggestions and recommendations defined by the therapist/physician 104 to the human user 106, or to provide other insights or observation on the health condition of the human user 106 to the therapist/physician 104.

The client computing device 112 may take a variety of forms such as a smartphone mobile computing device, a desktop computing device, a notebook computing device, a tablet computing device, or a specialized computer offering health management functions. The client computing device 112 is used to present one or more user interfaces to the human user 106, to collect, receive, process, display, and output information related to the therapy workflow. For example, the client computing device 112 may present a user interface to allow the human user 106 to review recommendations for therapy activities, to collect responses from the human user 106 on subjective results of the treatment (e.g., pain), to display a status of ongoing activities (such as exercises), and to receive and output the status of treatment recommendations from the therapist/physician 104, the health information system 102, or the supporter network 110. The client computing device 112 may include software or specialized hardware that is configured to communicate with a personal electronic device of the human user 106 used in connection with the therapy activities, such as a wearable device. The electronic communications 126 that occur between the client computing device 112 and the personal electronic device may be used for communicating sensor data, communicating device programming details, and exchanging information useful for the assistance of the therapy activities.

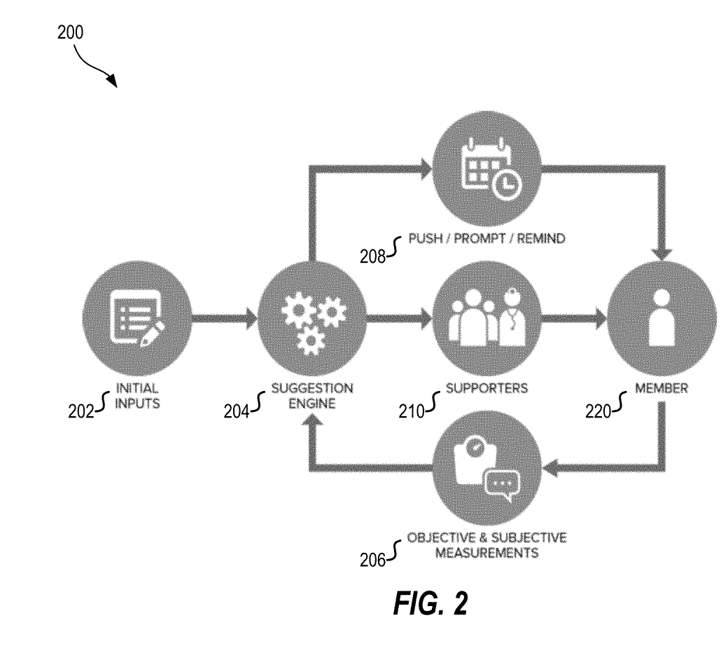

FIG. 2 illustrates an information flow diagram 200 for data communicated among users and information system elements according to an example described herein. For example, the information flow diagram 200 may be used to depict the flow of electronic data values and data representations in the therapy workflow of FIG. 1. Accordingly, the operations depicted in FIG. 2 may be implemented by the health information system 102, and the electronic communications among the health information system 102, the supporter network 110, the therapist/physician 104, the client computing device 112, and the human user 106.

As shown, a set of initial inputs 202 are received in the information flow. These initial inputs may include psychological profile questions, medical record information, and health status information (e.g., from the human user 106 and therapist/physician 104). The initial inputs 202 are provided to a suggestion engine 204 (e.g., operating in the health information system 102), to generate various suggestions, recommendations, and information content for use in the therapy workflow for a particular member 220 (e.g., the human user 106).

The suggestion engine 204 may provide content directly to the member 220 through the use of various suggestion content and therapy guidance, electronically delivered through pushed notifications, prompts, or reminders 208. The notifications, prompts, or reminders 208 may occur according to a defined playlist of suggestions and content, such as defined for therapy workflow activities according to a treatment regimen defined by a healthcare professional. Additionally, or alternatively, the suggestion engine 204 may provide content to the member through the use of supporters 210 (e.g., members of the supporter network 110), who may relay, modify, or enhance suggestions and related encouragements for the member 220.

A variety of objective and subjective measurements :206 may occur in the therapy workflow, provided from electronic data collected of prior physical activity with a personal electronic device (e.g., a wearable device) on the member 220, or through inputs and user interfaces being interacted with by the member 220. These measurements 206 are then communicated to the suggestion engine 204 for further processing, and for subsequent recommendations and suggested content to be customized to the measurements of the state of the member and the member's activities.

The suggestion engine 204 may be structured to process a variety of user preferences, proclivities, and biases towards certain activities in connection with the therapy workflow. For example, the suggestion engine 204 may apply inferences about types of therapies and therapy activities will work, external influences, environmental impacts, expected human behaviors, peer pressures, arid motivations, when determining the type, duration, timing, and other attributes of suggested therapy activities. For example, the suggestion engine may apply certain psychological motivators for performing therapy activities through the notifications, prompts, or reminders 208, or may apply peer pressure through interaction with the supporters 210. Accordingly, the suggestion engine 204 may utilize multiple channels and ways of communication, through multiple people, to assist the delivery of the dynamic therapy content.

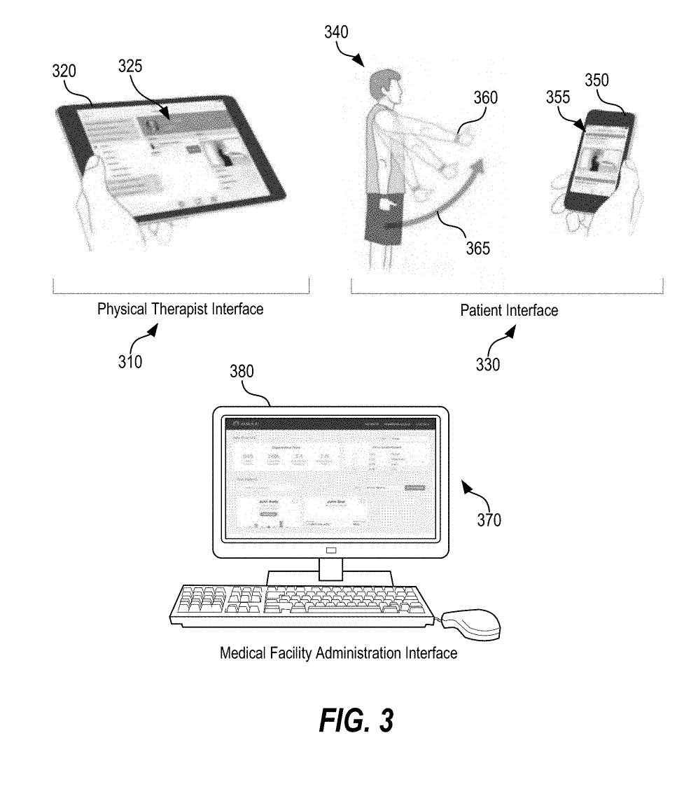

FIG. 3 illustrates therapist and patient user interfaces to a health information system (e.g., the health information system 102) according to an example described herein. The therapist and patient user interfaces may respectively offer content and interaction choices for the processing, delivery, and display of relevant therapy information in the therapy workflow, using the communication architecture depicted in FIG. 1 and processing activities depicted in FIG. 2. As shown in FIG. 3, a physical therapist interface 310 may be operated by a healthcare professional (e.g., a therapist) who is overseeing the specific type of therapy, whereas a patient interface 330 may be operated by the patient 340 (e.g., a member) as part of a home-based, outpatient, or external therapy session or regimen. Additionally, a medical facility administration interface 370 may be operated by a healthcare management professional such as an administrator who is overseeing activities of the therapist or is coordinating medical activities among patients and providers.

For example, the physical therapist interface 310 may be presented on a therapist-operated electronic computing device 320 (e.g., a tablet computing device). The physical therapist interface 310 may be implemented through an interactive graphical user interface 325 (e.g., software app) that displays information regarding the treatment and activity status of the patient 340, and receives input (e.g., gestures, text, audiovisual content) used to modify recommendations and suggested content for the therapy activities. In an example, the therapist may preview or observe a display of the recommendations or the suggested content as it is presented to the patient 340, including a status of whether certain therapy exercises have been viewed, attempted, and performed.

Also for example, the medical facility administration interface 370 may be presented on a management-operated electronic computing device 380 (e.g., a desktop computing device). The medical facility administration interface 370 may be implemented through an interactive graphical user interface such as a webpage that displays information for patients, therapists, groups of patients or groups of therapists, facilities, or medical organizations. In further examples, the medical facility administration interface 370 may provide customized information in respective interfaces for use by management of a clinic (e.g., overseeing a therapist or multiple therapists), a health system of a plurality of clinics, an employer, or an insurance company.

Also for example, the patient interface 330 may be presented on a patient-operated electronic computing device 350 (e.g., a smartphone computing device). The patient interface 330 may be implemented through a graphical user interface 355 (e.g., software app) that displays suggestion and guidance information to encourage, instruct, or control treatment activities by the patient 340. For example, the graphical user interface 355 may present audiovisual content generated or selected from the physical therapist interface 310 which relates to physical therapy exercise activities to be performed by the patient 340, such as a series of movements 365.

The movements 365 may be monitored by a wearable device 360 worn by the patient 340, and relevant monitoring information may be displayed to the patient 340 as part of the therapy activities within the graphical user interface 355. The relevant monitoring information from the wearable device 360 may further be collected and processed by the electronic computing device 350 to update the selection of suggestions, such as via communication of the monitoring information to a health information system, or communication of the monitoring information to a therapist-operated electronic computing device.

Interaction between the information system and the patient may be performed through the use of one or more hots, avatars, or virtual agents. The use of such virtual agents may improve patient engagement in an automated coaching platform, as the patient can design the personality of a coaching avatar over time. Such interaction with virtual agents is especially useful in scenarios where the patient is more likely to perform therapy activities that the coaching avatar recommends. The virtual agent may also incorporate features of adaptive learning and automation, to provide an additional layer over the therapy content obtained from the information system. This can provide a customizable new tool, in the form of a design-your-own-engagement-coach, while also exposing a new interaction loop in the information system focused on adaptation to the patient.

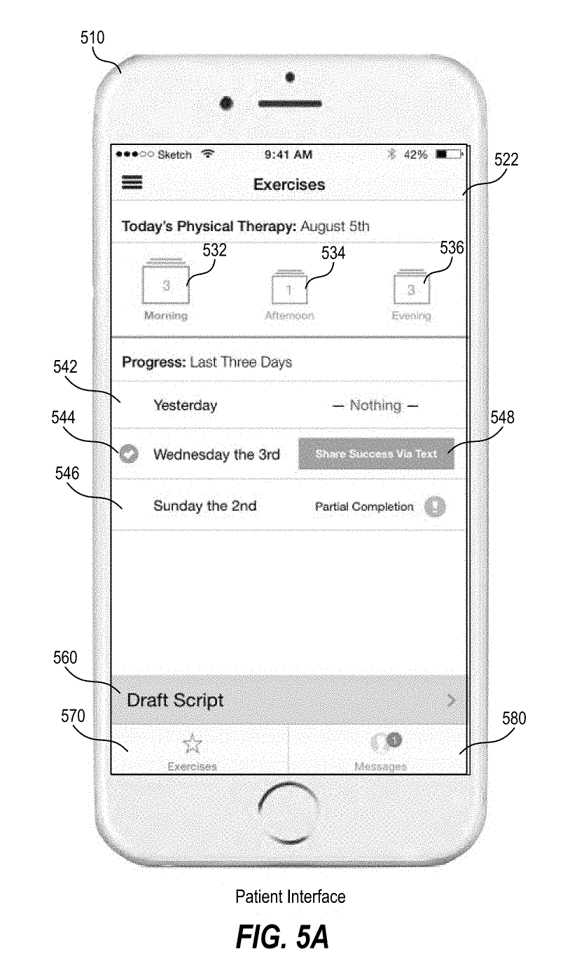

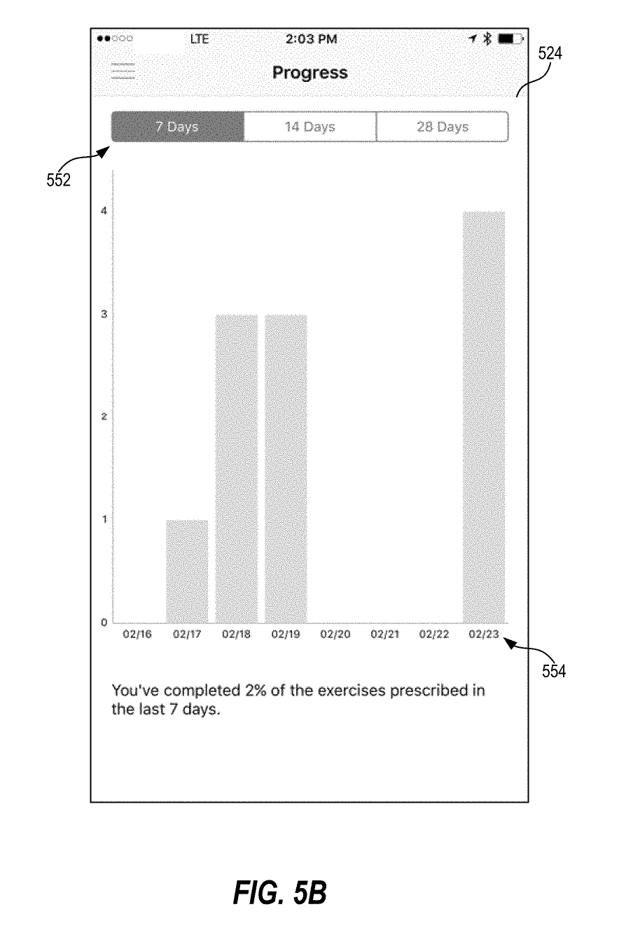

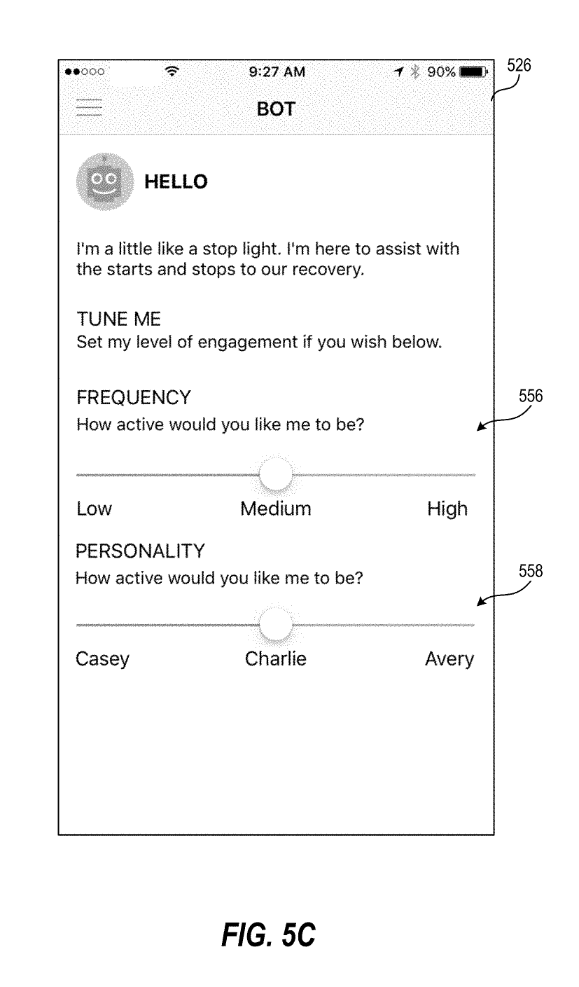

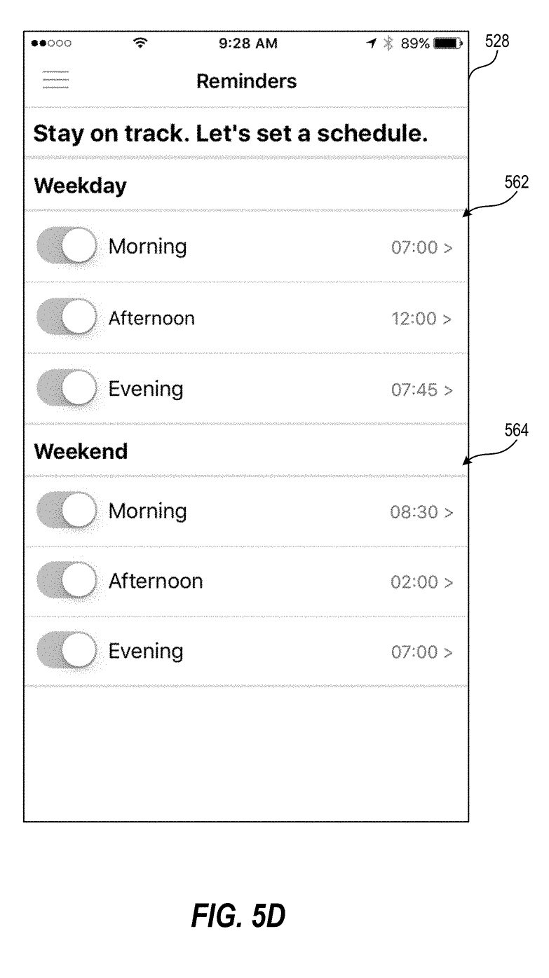

In a further example, the use of an automated agent may expose functionality from a suggestion engine, such as from a Bot that pushes forward suggestions of therapy activities that are time-tagged (with the Bot selecting and presenting one therapy activity from among a plurality of possible activities). The Bot (as described below with reference to FIG. 5C) may also provide sophisticated notifications with the use of a communication generator, and time-based delivery settings in which a user can establish varying types of reminders, notifications, and personality settings. As a result, the Bot may filter therapy-based suggested content to a particular personality of the patient and a particular time for delivery.

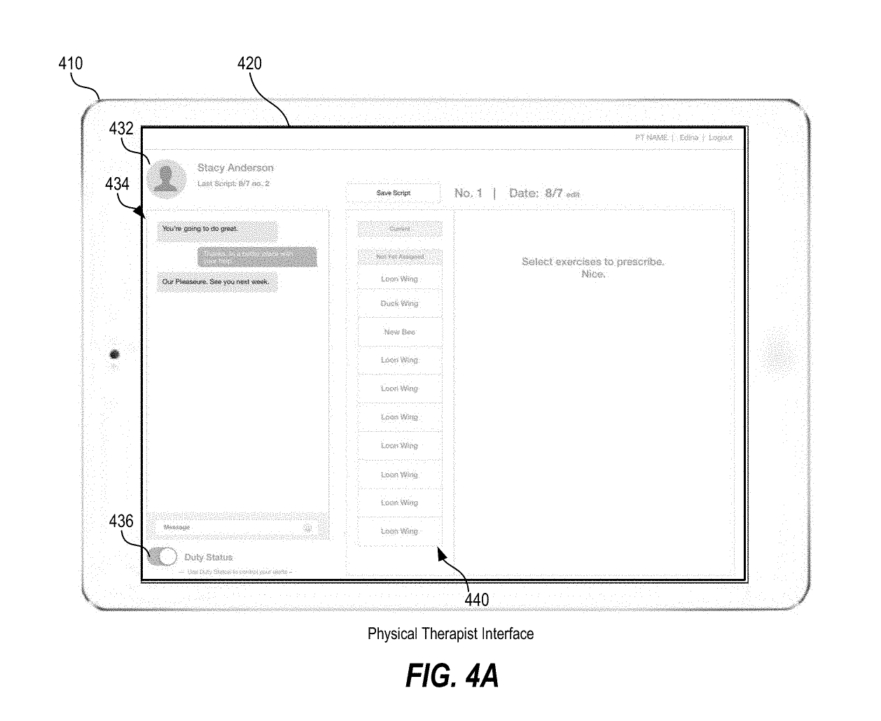

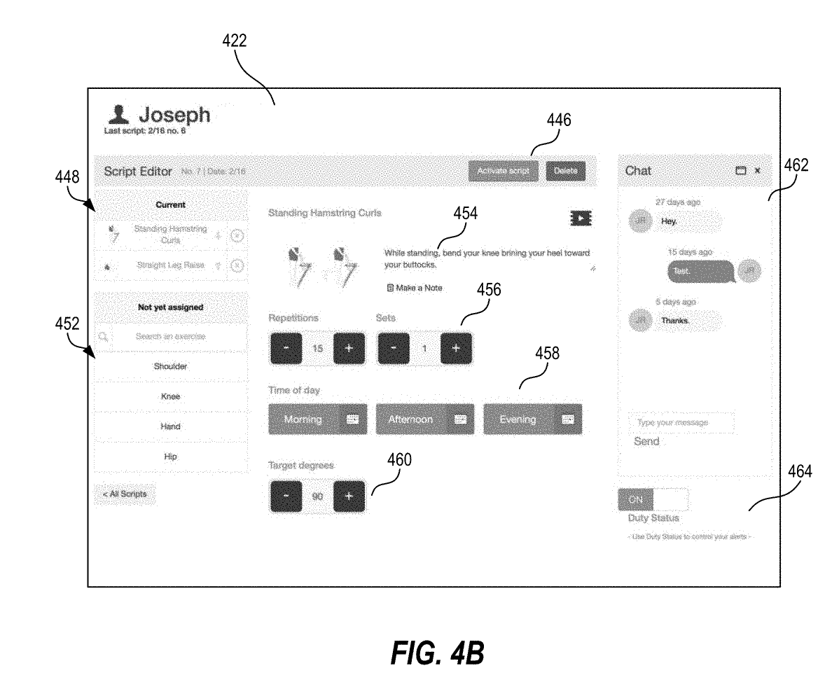

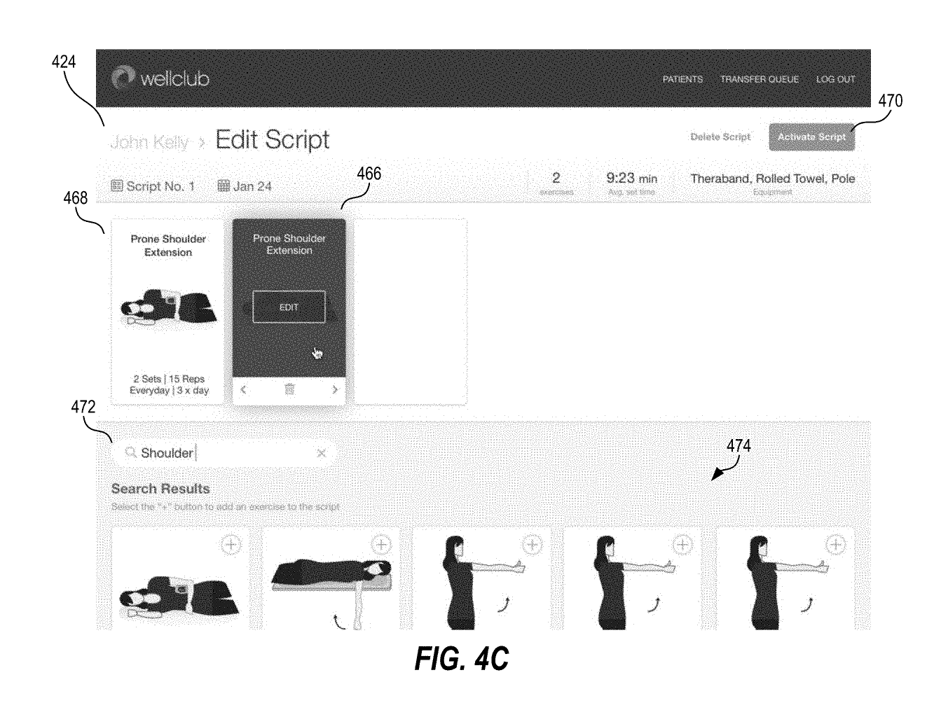

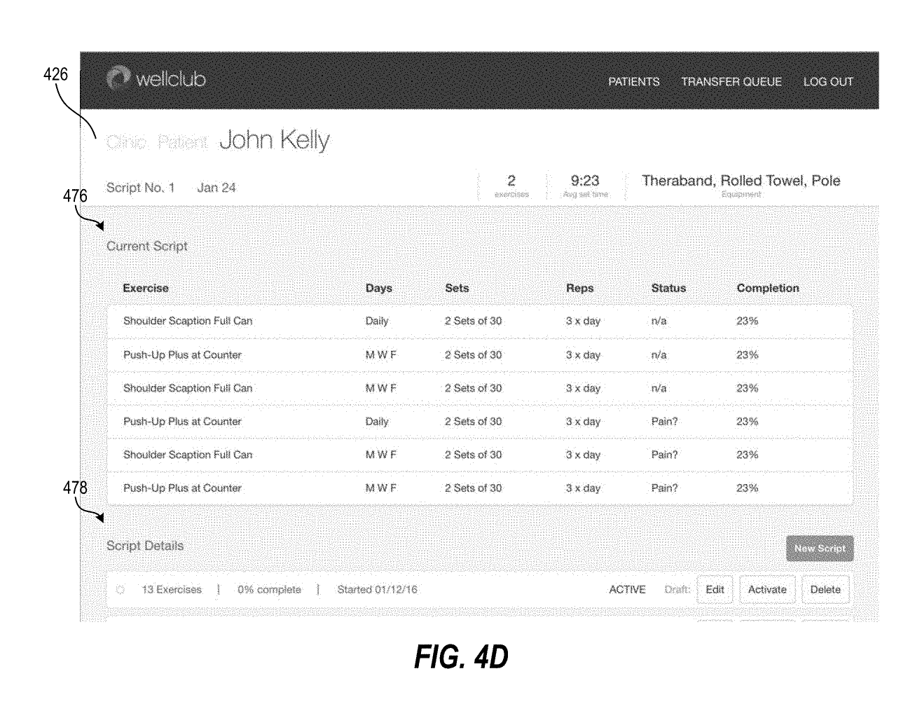

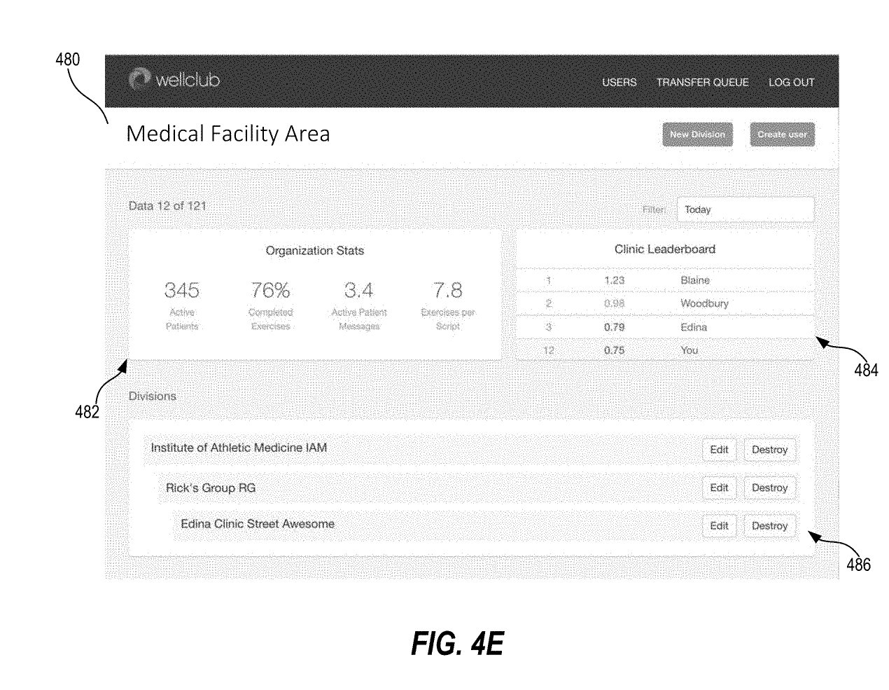

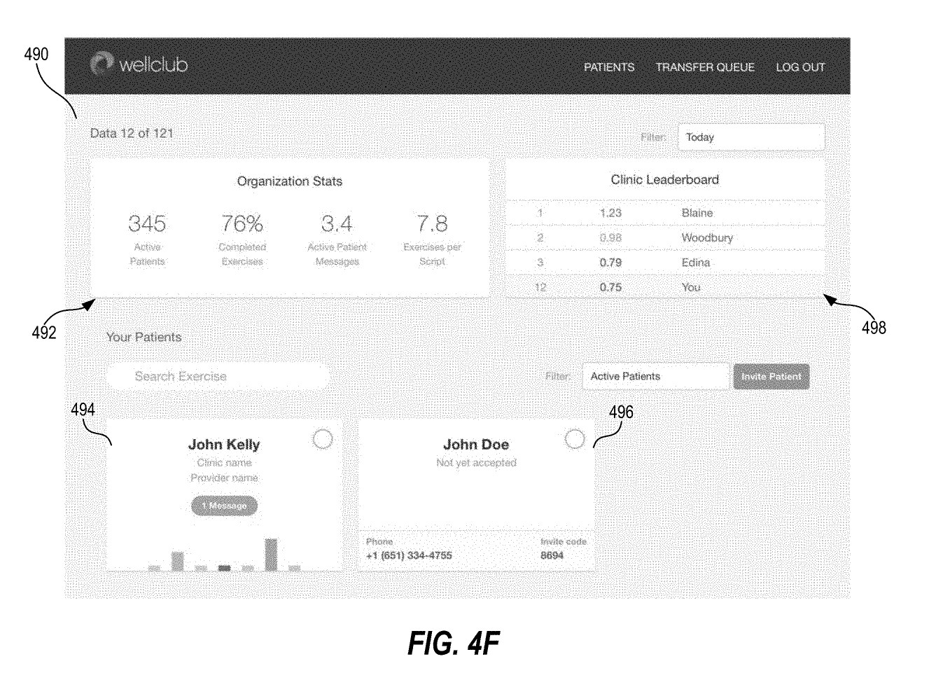

FIG. 4A illustrates features of a therapist user interface to an information system according to an example described herein. As shown, a graphical user interface 420 is rendered and displayed on a therapist-operated electronic computing device, such as may be provided through a software app, a web application, or like application interface operating on a tablet computing device 410. The graphical user interface 420 may include a variety of interaction and content output features, including a display of patient information 432, a communication session display 434 to facilitate a text or audiovisual communication session with a patient, a communication status control 436 to control whether to be “on duty” or visible to a patient, and a selection interface 444 to select and customize therapy activities for a particular patient. For example, a therapy activity script 442 for a particular patient can be created from a list of therapy activities 440, such as to provide a sequence and definition of suggested therapy activities such as exercises. Accordingly, it will be understood that the physical therapist interface may involve a variety of user interface screens, controls, and displays in order to provide user interface functionality for therapist, physician, or expert operations in the therapy workflow.

FIG. 4B illustrates further features of an example graphical user interface 422 as part of a therapist user interface to an information system, allowing a therapist to edit a therapy activity script or customize like portions of a therapy activity playlist for a particular human user (e.g., patient). For example, the graphical user interface may include a control option 446 to activate or delete a script for a user, define active and assigned scripts for a user in a listing of currently assigned scripts 448, locate and select additional scripts in a listing of script categories 452, edit a description or instruction for the therapy activity script 454, define a number of repetitions and sets of a particular therapy activity 456, define a time of day 458 for performance of the therapy activity script, and define a target degree 460 for performance of the therapy activity. The graphical user interface 422 may also include features to perform messaging 462 and to change an availability status 464 for the therapist, to correlate with the scheduled performance of the therapy activity, therapy session, or other forms of coaching.

FIG. 4C illustrates further features of an example graphical user interface 424 for selecting and editing a therapy activity script for a subject user (e.g., a patient). For example, the graphical user interface 424 may be used by a therapist for scheduling sets and repetitions of particular therapy activity scripts, adjusting the order or active status of one or multiple therapy activity scripts, or adjusting other aspects of a therapy regimen. The graphical user interface 424 may present predefined playlists and scripts that may be selected, edited, deleted, and activated (e.g., with script control 470), such as for activating a first therapy exercise set 468 and second therapy exercise set 466. The graphical user interface 424 may also provide an interface to access actionable sets of additional scripts such as through a search interface 472 and a selection interface 474 that provides graphical representations of various therapy activities.

FIG. 4D illustrates further features of an example graphical user interface 426 to provide a visual display and control of a therapy activity script for a particular patient according to an example. For example, the graphical user interface 426 may provide a listing of therapy activities 476 activated in the script, including a listing, days scheduled, sets scheduled, repetitions scheduled, and a pain and completion status of the respective therapy activities. The graphical user interface 426 may also include scripting options 478 to edit, activate, or delete a specific activity.

FIG. 4E illustrates features of an example graphical user interface 480 that may be provided as part of a medical facility management user interface to an information system. For example, the graphical user interface 480 may include a dashboard to display organization statistics 482, respective facility information 484, and organization information 486. This dashboard may provide a display to compare metrics of patient activity and engagement, such as how often are patients at a specific location performing prescribed scripts or exercises. These statistics may be based on aggregated information across multiple sets of patients, therapists, or associated groups.

FIG. 4F illustrates features of an example graphical user interface 490 that may be provided as part of a medical facility management user interface to an information system, further to the example depicted in FIG. 4E. For example, the graphical user interface 49( )may include another dashboard to allow visualization of organization statistics 492 and information for respective facilities 498, in addition to a visualization of treatment statistics 494 or contact information 496 for one or more patients of a specific therapist. As a result, the graphical user interfaces 480, 490 may allow a healthcare management entity to observe best outcomes by therapist, geographic location, type of injury, clinic, or like data points.

Accordingly, the interfaces shown from FIGS. 4A to 4F provide examples of interfaces that allow a health care provider to review, edit, and visualize therapy activities and status. Other variations to these interfaces may include dashboards for presenting therapy status to different types of users (e.g., a surgeon, specialist, or general practitioners), such as to ensure that a subject patient is (or a group of patients are) performing the prescribed exercises correctly. Other interaction features provided to a health care provider may enable communication and status updates to respective patients or a group of patients, such as through a texting or messaging application to interact with a therapy group.

FIG. 5A illustrates features of a patient user interface to a health information system according to an example described herein. As shown, a graphical user interface 522 is rendered and displayed on the patient-operated electronic computing device, such as may be provided through a software app, a web application, or like application interface operating on a smartphone computing device 510. The graphical user interface 522 includes a display of a set of therapy activities, such as exercises, including a therapy regimen for a particular day, along with a set of activities being organized by a morning display 532, afternoon display 534, and evening display 536 of activities.

Within the display of the set of therapy activities, an indication of therapy progress or other therapy statuses can be displayed, including a time-based status in a prior day display 542, a current day display 544, and a future day display 546 of activity statuses. For example, the status displays may indicate a completion status, including a status of therapy workflow assignments, partial or full assignment completions, and like indications based on determinations of activities from the health information system or the application. The status displays may also he accompanied by user interface controls to perform interaction actions, such as control 548 to allow sharing status with one or more supporters, a therapist, or other social users.

The graphical user interface 522 display of the patient interface may be accompanied by progress information including a selection for a script of therapy activities 560, a selection of additional therapy activities 570, and a section of messages or other electronic communications 580. Accordingly, it will be understood that the patient interface may involve a variety of user interface screens, controls, and displays in order to provide user interface functionality for patient operations in the therapy workflow.

FIG. 5B illustrates a screenshot of a graphical user interface 524 configured to display a progress status for a number of prescribed therapy exercises by a user. The graphical user interface 524 may include a selection interface 552 to define a time interval (such as 7 days, 14 days, 28 days, etc.) and a time-based graphical display such as a chart 554 that indicates the progress status over the time interval. The progress status may be accompanied by a textual display to provide encouragement or recognition for the completed activities.

FIG. 5C illustrates a screenshot of a user interface 526 configured to enable the customization of interaction settings used with a Bot. In an example, reminders may be delivered to a user based on a selection of a Bot activity setting (selected with user interface control 556) and a Bot personality setting (selected with user interface control 558). The Bot may be used to establish and customize a reminder schedule, such as to introduce an element of personality based on different coaching styles and interaction reminders, suggestions, or prompts with the human user. Further, the Bot may be used to implement a simplified version of personality profiling during the therapy workflow, to allow interaction messages and notifications to be provided according to the timing arid content characteristics of a Bot. In this way, the customization provided by a Bot may be used to increase chances of obtaining a positive response from a human user.

FIG. 5D illustrates a screenshot of a user interface 528 configured to enable the customization of reminder settings, such as for reminders to perform therapy exercise activities. For example, a set of reminder times to perform particular exercises may be presented at three times (Morning, Afternoon, Evening) during weekdays (Monday-Friday), as indicated by a customizable weekday schedule 562; a set of reminder times to perform particular exercises may be presented at three times (Morning, Afternoon, Evening) during weekend days (Saturday-Sunday), as indicated by a customizable weekend schedule 564. The user interface controls provided in the user interface 528 may provide the ability to change or activate/deactivate reminders based on these schedules or other inputs received from the user (or Bot).

Other features of the client user interface may enable status displays and messaging, including interaction with episodic questions and suggestions. Such messaging may be provided in questions such as: “Have you made your appointment today?” “How is your pain level?”, or custom content as defined by a therapist. Other features of the client user interfaces may be designed to encourage patient engagement with the treatment program or with a group of supporting users, while collecting useful information from the user (such as how long the exercises are performed, what problems are encountered) for the treatment activities.

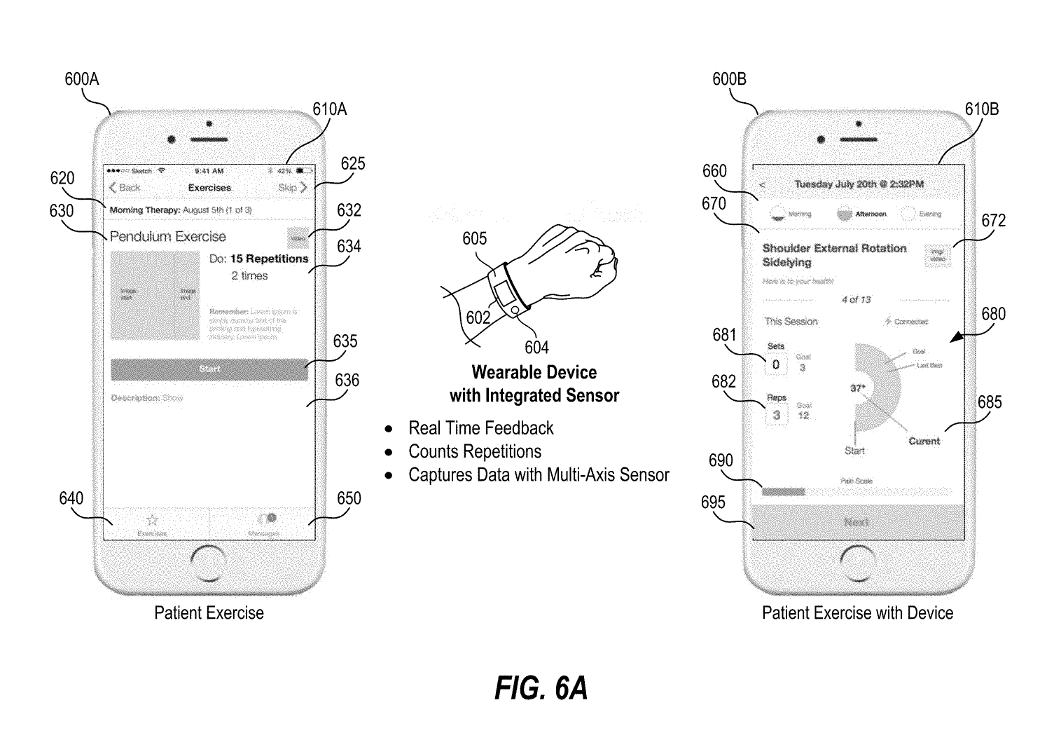

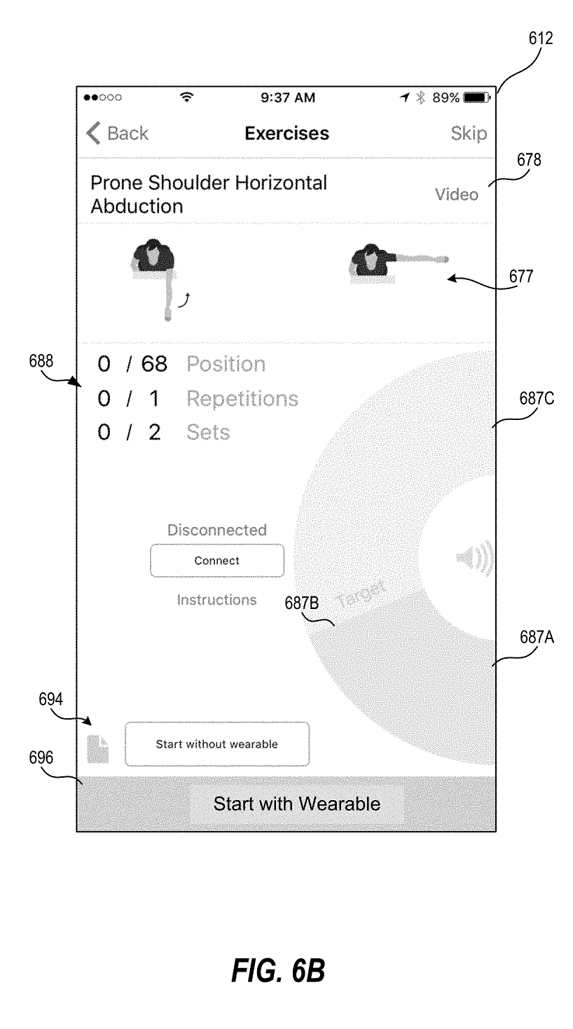

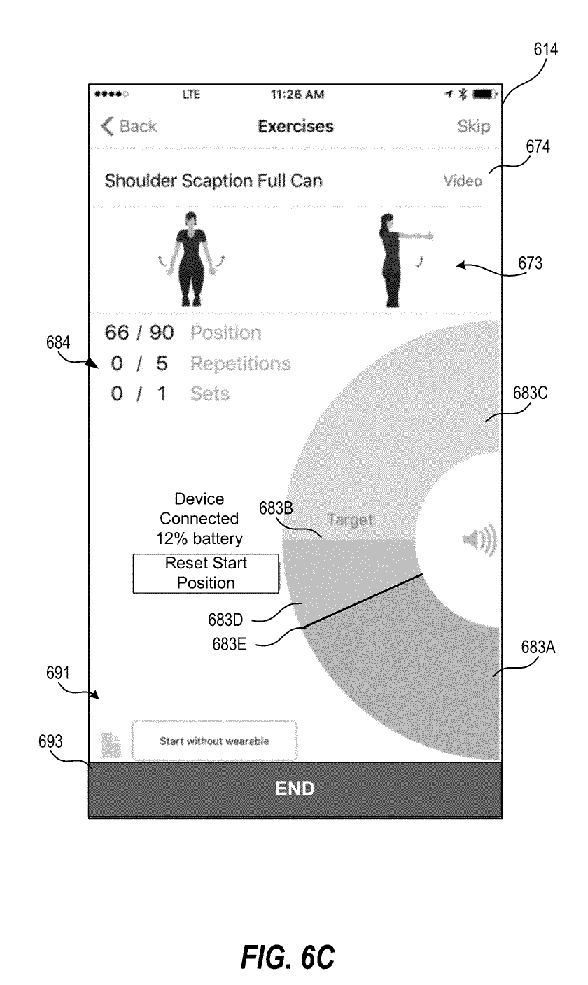

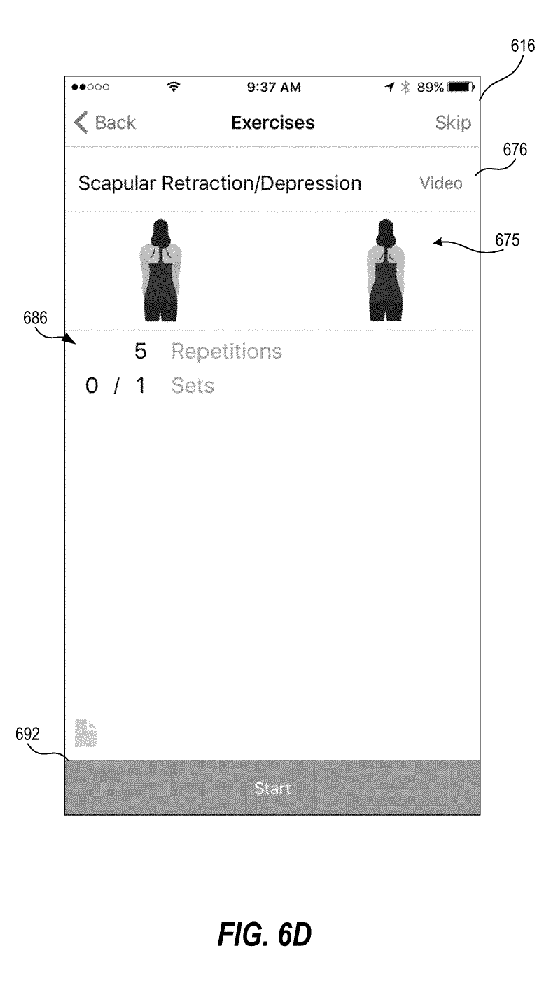

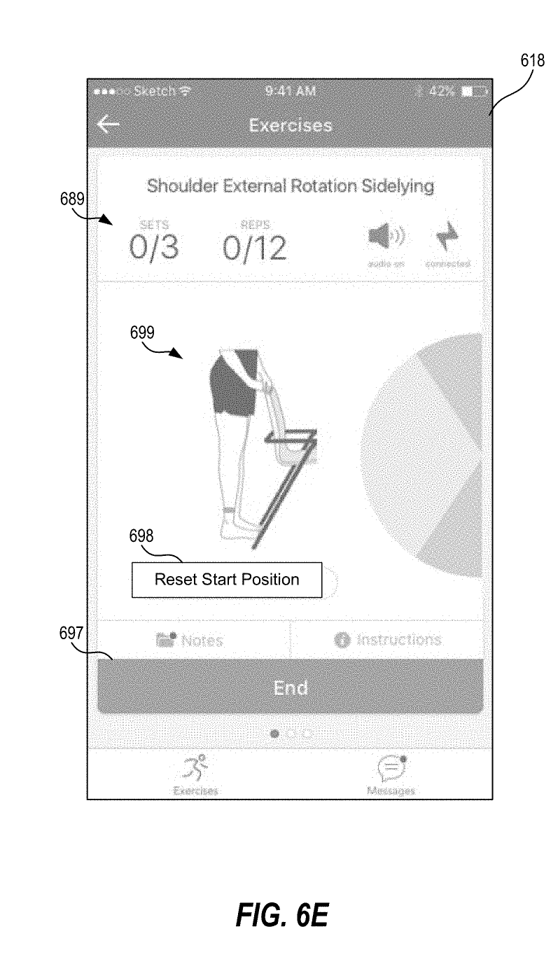

FIG. 6A illustrates additional features of patient graphical user interfaces 610A, 610B operating on a mobile computing device 600A, 600B, including user interface interactions with an integrated sensor device 605 according to an example described herein. The integrated sensor device 605 may be provided in a wearable form (e.g., for wearing on a patient's arm or leg), arid may include a sensor (e.g., a multi-axis sensor allowing measurements in 3, 6, or 9 axes, gyroscope, accelerometer, magnetometer, barometer, geolocation sensor, optical sensor, temperature sensor, chemical sensor, or stretch/pressure/impact sensor), a display 602 (e.g., a LCD or LED screen), circuitry (e.g., integrated circuitry to collect information from the sensor and output information with the display 602), and a LED 604 (e.g., to display operational status of the wearable device). Other variations to the integrated sensor device 605 without the LED 604 or the display 602 may be used. Further, wired and wireless communication capabilities and other forms of physiological data sensors may be provided within the integrated sensor device 605.

As shown, the patient graphical user interface 610A shows an indication of a graphical user interface display for a therapy session listing 620, including an indication of a particular physical therapy exercise 630. In the patient graphical user interface 610A, the therapy information may include a description and instructions 634 for the physical therapy exercise 630, audiovisual content such as a selectable option 632 to display a video of the physical therapy exercise 630, a description 636 of the physical therapy exercise 630, and a user interface control 635 to start a physical therapy session for the particular physical therapy exercise 630. Other interface options may include a listing of activities (such as a listing of exercises 640), a listing of communications (such as a listing of messages 650) associated with the therapy session(s), audio feedback and outputs to the user, and navigation selections 625 such as the ability to skip or advance to other therapy activities.

The described physical therapy exercise 630 may involve the use of a personal electronic device, such as the integrated sensor device 605 in a handheld apparatus form factor. The integrated sensor device 605 may include a variety of sensors to count exercise repetitions, collect and communicate data, and provide real-time feedback to the patient graphical user interface 610B. For example, as shown, the patient graphical user interface 610B includes an indication of the status of therapy activities in a therapy session listing 660, a description of a particular physical therapy exercise 670, audiovisual content such as a selectable option 672 to display a video of the physical therapy exercise 670, and a graphical display 680 of a status of the physical therapy exercise 670 from sensor feedback.

The type of sensor feedback that may be provided in the patient graphical user interface 610B may include: a display of the number of sets for an activity 681, a display of the number of repetitions for an activity 682, a real-time (or near real-time) graphical display 685 for a measurement of the quality for an activity (such as doing the exercise too fast, too slow, or correctly), a measurement or indication of pain 690 (such as may be measured by a sensor or input by the patient), and like status indications based on use of the integrated sensor device 605 during the therapy activity. The user interface may also present other user interface controls such as a control 695 to navigate to a next activity, a next session, or next goal.

The use of the sensor device 605 may provide the ability to not only measure and verify compliance with a particular therapy activity, but also monitor and display a progress (and an indication of how much the patient has improved), and provide specialized feedback such as from holding an exercise position for a certain period of time. In further examples, other forms of physiological measurements may occur with use of the wearable device, such as specific biomechanics measurements or chemical characteristic (e.g., blood chemistry) measurements. Thus, a variety of data types collected by the wearable device may provide a perspective of the performed exercise(s) in addition to the patient's overall health status.

FIG. 6B provides an illustration of a further graphical user interface 612 to present a particular exercise therapy (e.g., a shoulder exercise) to a user, according to an example. As shown, the interface for this exercise therapy includes a graphical illustration 677 of the therapy (which may be provided by an animated GIF, for example), a video link 678 to display a video example of the therapy, a listing of the therapy activities 688 (including a number of repetitions and sets), and a status tracker of the therapy activity. As shown, the status tracker may designate a targeted exercise area 687A (in the prescribed range) and an untargeted exercise area 687C (out of the prescribed range), and an exercise target 687B, which correspond to positions in a range of motion for a particular exercise therapy. The graphical user interface 612 may further include a selection option 694 to start the exercise repetitions without the use of a wearable (e.g., based on timed repetitions), and a selection option 696 to start the exercise repetitions with use of the wearable (e.g., based on sensor data, indicated with real-time progress in the targeted exercise area 687A and the untargeted exercise area 687C).

The graphical user interface 612 may provide a status indication on the targeted exercise area 687A or the untargeted exercise area 687C to output real-time feedback during the performance of the exercise therapy. This status indication may be based on raw or composite position data received from the wearable device. For example, a software application providing the graphical user interface 612 may obtain and process raw data horizontal, vertical, or latitude times altimeter data, to determine a real time graphical representation that is overlaid on the targeted exercise area 687A or the untargeted exercise area 687C. This graphical representation can be provided as real time feedback to improve the quality and safety of the exercise.

FIG. 6C provides an illustration of another graphical user interface 614 to perform a shoulder therapy exercise according to an example. Similar to FIG. 6B, the graphical user interface 614 includes a graphical illustration 673 of the therapy, a video link 674 to display a video example of the therapy, a listing 684 of the therapy activities (e.g., listing a number of repetitions and sets), a selection option 691 to perform the therapy exercises without use of a wearable device, a selection option 693 to stop performance of the therapy exercises, and a status tracker. Similar to FIG. 6B, the status tracker may designate a therapy exercise range area 683A, 683D (inside the prescribed position range) and an untargeted exercise area 683C (outside the prescribed position range), and an exercise target 683B, which correspond to positions in a range of motion for a particular exercise therapy.

As shown in FIG. 6C, the status tracker provides a real-time representation of the position (66/90), with the use of a position status indicator 683E and separate indications of a completed exercise area (in exercise range area 683A) and an uncompleted exercise area (in exercise range area 683D). As data is received from the wearable device that indicates a change in the position, the position status indicator 683E may move in real-time, thus encouraging the user to complete the exercise activity towards the exercise target 683B.

In a further example, the graphical user interface may provide an indication of the quality of movement, to allow the user to be informed not only on the status of the exercise, but also the quality of the exercise. For example, a quality measurement may be displayed to allow a user to observe how often a target is met (or exceeded), whether positioning of the sensor was correct or correct, other variations to the therapy activity that is performed. This indication of the quality of movement may be presented through a graphs, charts, a numerical display, or like outputs.

FIG. 6D provides an illustration of another graphical user interface 616 to perform another shoulder therapy exercise according to an example. Similar to FIG. 6C, the graphical user interface 616 includes a graphical illustration 675 of the therapy, a video link 676 to display a video example of the therapy, a listing 686 of the therapy activities (e.g., listing a number of repetitions and sets). However, the graphical user interface 614 may present an illustration of the therapy activity without real-time feedback from a wearable device. For example, the graphical user interface may include a start option 692 (which is replaced by an end option, not shown) along with a countdown timer feature (not shown) to guide a user to performance of the therapy activity without feedback from the wearable device.

FIG. 6E provides an illustration of another graphical user interface 618 provided to a user to assist performance of another shoulder therapy exercise according to an example. In the graphical user interface 618, a listing of sets and repetitions of the therapy exercise 689 are provided for real-time (sensor assisted) or manual tracking, along with an illustration 699 that provides an animation of the therapy exercise. The graphical user interface 618 may include a reset control 698 to reset the start position of the therapy exercise, and an end control 697 to stop or end the therapy session. In a further example, the illustration 699 may provide an animation that corresponds the real-time progress of the therapy exercise, based on data received from the sensor device.

In an example, the sensor device (e.g., the integrated sensor device 605) may be provided with functionality of a MEMS (microelectromechanical) sensor. For example, a MEMS sensor may be located in a specific device holder or within another personal electronic device, to communicate with the computing device (e.g., the mobile computing device 600A, 600B) via a Bluetooth connection. In an example, the integrated sensor device 605 includes sensors to measure motion of the device when attached to the person, and motion of the person for performing specific therapy activities.

As illustrated with the previous examples, the integrated sensor device 605 may perform a measurement of variable attributes such as acceleration, movement, range. For therapies such as knee/low back/shoulder physical therapy, the use of such a device during exercise may help facilitate at-home or self-performed activity, feedback, and guidance. In other examples, inputs may be dynamically determined on an ongoing basis for diabetes or hypertension conditions using physiological sensor data from wearable or implantable devices, such as pulse oximetry level, glucose level, blood pressure, heart rate, chemical levels, and the like (including from sensor measurements occurring within the medical device itself).

Applicable sensors and sensor functionality included in such personal electronic devices (e.g., in wearables) supported by the present workflows may include: motion detection (for motions such as acceleration, rotational movement, or directional movement); physical attribute detection (for heat, moisture, light, gas level, stretch levels, and the like); physiological attributes (e.g., heart rate, blood oxygen, blood pressure, and the like). The data generated from such sensors may be processed directly at the device (e.g., with the integrated sensor device 605), communicated to a smartphone (e.g., mobile computing device 600A, 600B) for processing, or communicated to a health information system for processing. It will be understood, however, that similar interactions and data may be conducted with other types of sensors, wearables, and personal electronic devices.

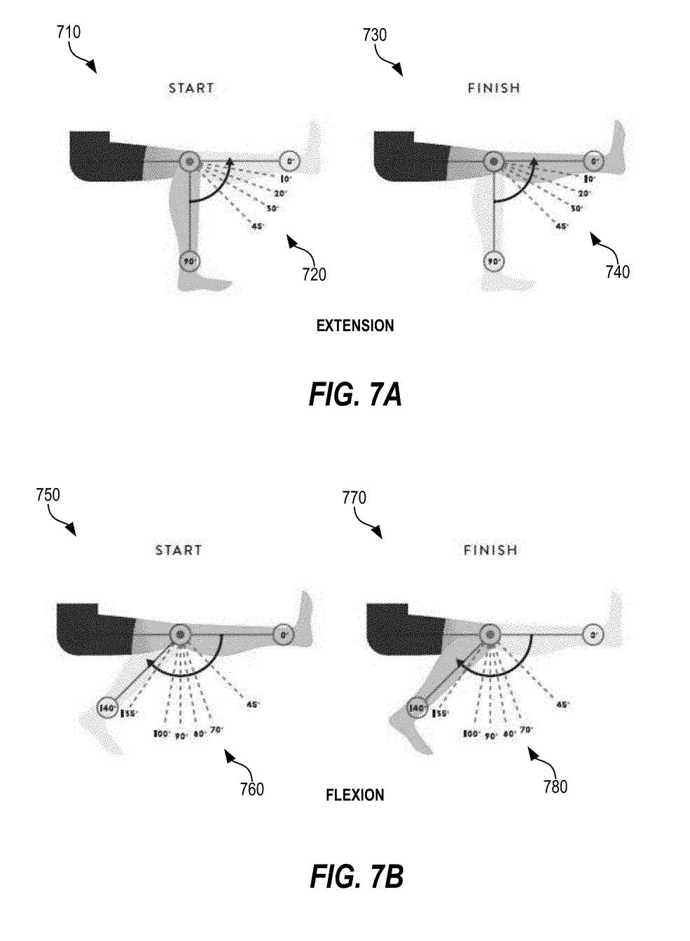

FIGS. 7A and 7B illustrate measurements of a range of motion obtained from physical therapy exercises that may be monitored and tracked for with a wearable device and a health information system according to an example described herein. For example, a wearable device worn by a patient (e.g., on the patient's leg) may be used to monitor a starting position 710 and a finishing position 730 of an extension exercise, as shown in FIG. 7A; a wearable device worn by a patient may likewise be used to monitor a starting position 750 and a finishing position 770 of a flexion exercise, as shown in FIG. 7B.

The wearable device may collect data to indicate the specific degree of extension 720, 740 or degree of extension 760, 780 obtained during the respective exercises, including data indicating the rate of motion and movement, whether resistance or pain is encountered at a particular degree of extension or flexion, the number of repetitions, and whether the exercise being performed is compliant with a predetermined therapy range. The wearable device may provide feedback before, during, or after the exercise using one or more vibrations, audio output, or a visual display, e.g., to provide a vibrating pulse when the extension or flexion exercise reaches a determined degree. The wearable device may also wirelessly communicate information about the extension and flexion exercises to a computing device or to a health information system during the exercise, to provide dynamic measurements and real-time evaluation of the exercise and therapy compliance.

As an example of the therapy workflow in a total knee replacement, a patient may visit a doctor's office before surgery, with the doctor providing an overview of the exercises. The first day after surgery, the flexion and extension exercises may be monitored and guided by a therapist through use of the graphical user interfaces and the wearable device monitoring. Based on the collected data, any of the medical providers involved in the patient's care (including the therapist, specialist, surgeon, or other medical professional) can monitor the performance of the exercises and compliance with the treatment regimen, including reviewing the data at any follow-up visit. Further, the use of real-time feedback may allow the patient to visually observe an indication of whether the extension or flexion exercises are being performed fully and correctly (such as indicating whether the prescribed degree of extension 740, 780 is being reached).

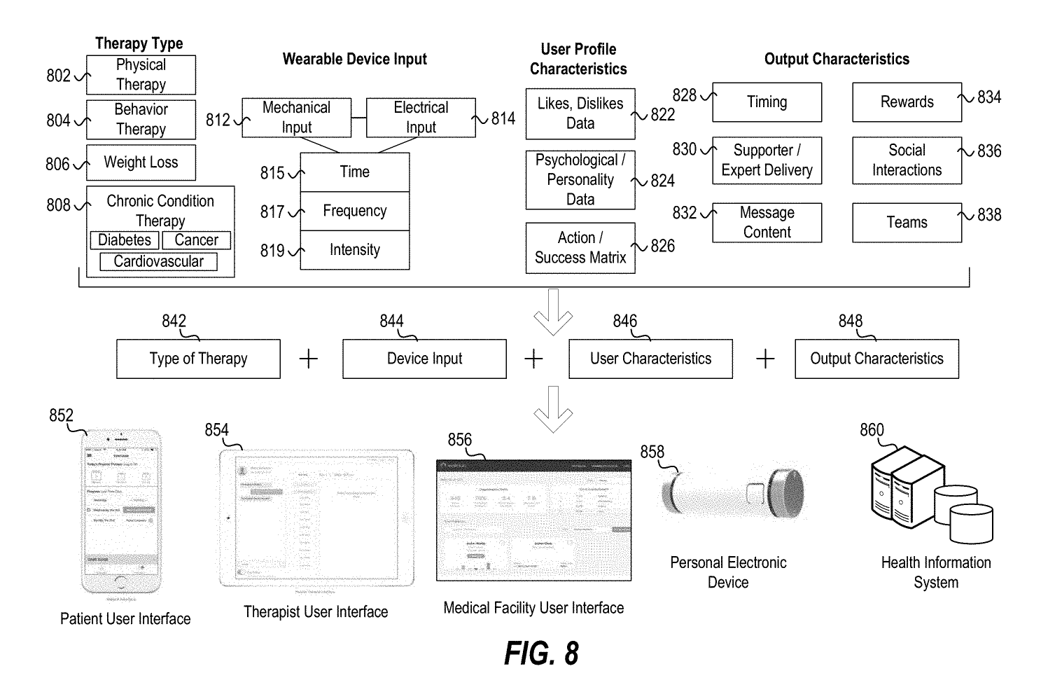

FIG. 8 illustrates inputs and outputs of data processed in a health information system according to an example described herein. As shown, the inputs that are collected may include a type of therapy 842, device inputs 844, user characteristics 846, and output characteristics 848. The results of these inputs may be used to drive the outputs and control of one or more patient user interface outputs 852, one or more therapist user interface outputs 854, one or more personal electronic device outputs 858, and one or more health information system outputs 860. The outputs 852, 854, 856, 858, 860 may be provided using any of the previously described activities, exercise regimens, and workflows.

The inputs that are provided for the type of therapy 842 to be processed in the health information system may be dependent on the specific variation of therapy and therapy activities, such as a physical therapy definition 802, a behavior therapy definition 804, a weight loss therapy definition 806, and a chronic condition therapy definition 808 (e.g., to support therapies for chronic conditions such as diabetes, cancer, heart disease or hypertension, and the like). It will be understood that a variety of sub-therapy types and variations (such as different types of physical therapy) may be included and defined as inputs.

The input types that are provided for the device inputs 844 to be processed in the health information system may include inputs from a wearable or other user-manipulated device. For example, the device inputs 844 may be provided from a device collecting mechanical input 812 and electrical input 814 (or some combination of electromechanical measurements, biofeedback, and the like) that establish a usable wearable data stream, along with input characteristics relative to time 815, frequency 817, and intensity 819. From these input characteristics and types, the device inputs 844 may reflect a variety of characteristics as to the efficacy and usefulness of the therapy activities conducted by the individual patient.

The inputs that are provided for the user characteristics 846 to be processed in the health information system may include features of a stored user profile, including likes and dislikes data 822, physiological or personality data 824, and an action/success matrix 826 that tracks the success or failure of individual activities. For example, the selection of subsequent activities may be customized to the preferences, personality, and likelihood of success for the specific activities. Other forms of physiological data, including data from third party services, cloud-based services, or medical information systems, may be provided as an input that is specific to the user and user profile.

The characteristics that are provided to be processed as output characteristics 848 in the health information system may include various features such as timing characteristics 828, settings for supporter or expert delivery 830 (e.g., from a therapist or coach), message content settings 832, reward actions and offers 834, social interaction characteristics 836, and team characteristics 838 (e.g., characteristics and definitions of groups).

In one example, the outputs 852, 854, 856, 858, 860 may include or indicate data for a “quality of therapy” measurement, which is derived from various device measurements to determine a quality of execution of therapy. This measurement may be used to show a doctor, therapist, or other expert how well the patient is following the therapy. The quality of therapy measurement may be represented in an on/off state, as well as a gradual/incremental state. Accordingly, the quality of therapy measurement may capture the difference between what happens in the clinic in a therapy session, versus outside the clinic such as in exercises occurring at home. The types of calculations used for this measurement may include: an improvement in weight, number of repetitions, or the amount of pain reported for a certain therapy exercise; a percent of compliance to a prescribed session; or other objective metrics.

In another example, the outputs may include a “quality of exercise” measurement, which is derived from the patient's behavior and execution of specific exercises or activities. In some examples, this “quality of exercise” measurement is correlated or represented by a “quality of motion” measurement for The types of calculations used for a quality of exercise measurement may include: staying within a predestined volume of activities; a percent of amount of time reaching exercise or activity goals; and related objective metrics from the performance of specific activities.

Both of the quality of therapy and quality of exercise measurements may be output to different persons involved with the therapy, such as a patient, caregiver, coach, therapist, doctor. Further, returning to the examples of FIG. 6, a variety of displays for the quality of therapy and the quality of exercise measurements may be provided in the graphical user interfaces 610A, 610B as feedback during the therapy activities.

Based on the data collected, and the “Quality” score, a mobile app can coach a patient to perform a physical therapy exercise in a certain way, or provide a suggestion in real-time how to do the exercise more effectively or safely. A variety of graphical outputs, alerts, or user interfaces might be provided in a mobile app, website, etc., to indicate the quality of therapy or quality of exercise. These graphical outputs may depict: a percentage of measurement within the bounds; real time measurement of motion; a percentage of time or amount of following the prescribed activity.

The wearable device input that is provided from the mechanical input 812 and the electrical input 814 is distinguishable from patient-reported data (e.g., from a questionnaire), as the wearable device input provides accurate information on timing 815, frequency 817, and intensity 819 of therapy activities that cannot be replicated from human observations. The wearable device input thus may provide an automated data source or “data stream” for therapy goals, using automated objective collection techniques instead of subjective (and even corrupted) human entry techniques. This provides a higher level of trust that may be tracked in the information system with an accompanying “trust score” or “confidence score” of measurements for certain conditions occurring with a particular patient. In further examples, the wearable device input may provide data as an input for predictive scores, such as providing a score based on past data, patient behavior, monitored events, compliance, and therapy conditions. Such predictive scores may be further adaptive to patient input and caregiver therapy considerations.

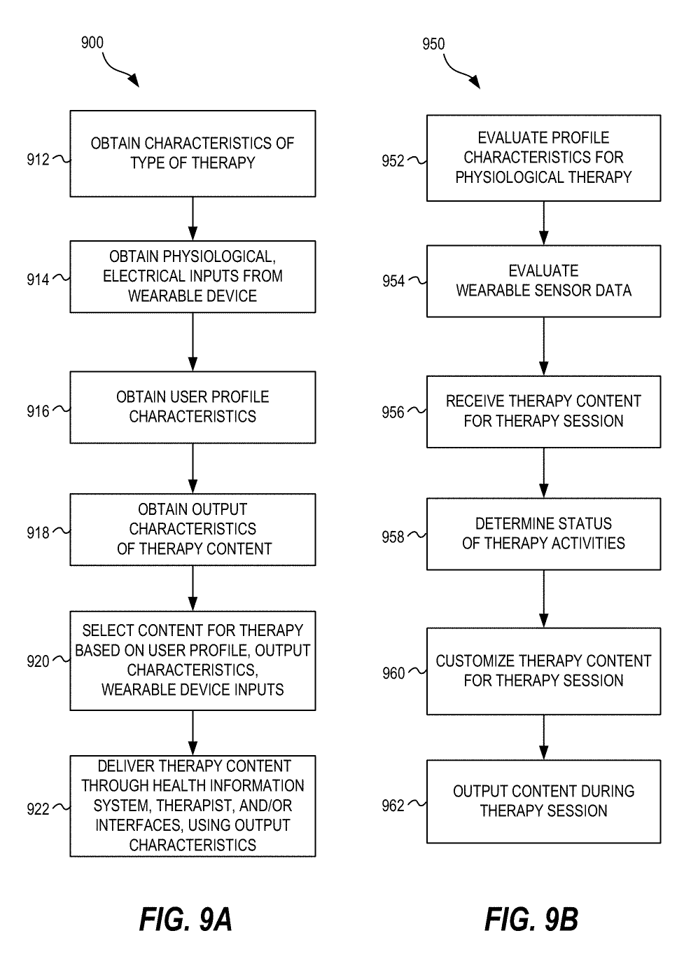

FIG. 9A illustrates a flowchart 900 depicting operations for a method of therapy and health monitoring using a personal electronic device according to an example described herein. As shown, the flowchart 900 depicts a sequence of operations that may be performed by one or more electronic devices such as a patient mobile computing device, a therapist computing device, or the health information system. It will be understood that variations to this sequence, and the involvement of multiple devices and systems, may also implement the method.

As shown, the method includes a series of operations to obtain relevant inputs for the therapy workflow, including obtaining characteristics on the specific type of therapy (operation 912), and obtaining physiological or electromechanical inputs from a wearable device used during the therapy (operation 914). The other relevant inputs may include obtaining user profile characteristics, such as those tracked by a health information system (operation 916), and obtaining output requirements of therapy content (operation 918), such as may be defined by a therapist or within a health information system.

From on the inputs and the desired output characteristics, various content items may be selected for the patient and desired therapy. For example, the content items may be customized based on matches with a user profile, customizations to defined output characteristics, and the values of wearable device inputs (operation 920). The content items may be further delivered through one or a combination of the health information system, a therapist, graphical user interfaces, device settings, and the like, according to the output characteristics (operation 922).

FIG. 9B illustrates a flowchart 950 depicting operations for a further method of physiological therapy and health monitoring using a personal electronic device according to an example described herein. Again, the flowchart 950 depicts a sequence of operations that may be performed by one or more electronic devices such as a patient mobile computing device, a therapist computing device, or the health information system. It will be understood that variations to this sequence, and the involvement of multiple devices and systems, may also implement the method.

As shown, the method of the flowchart 950 includes the evaluation of profile characteristics for aspects of physiological therapy (operation 952), such as the evaluation of personality characteristics that are associated with a particular human user or other medical or personal data that may assist the performance of the physiological therapy by the human user. Before or during the performance of this physiological therapy session, the exercises or activities of the physiological therapy (performed by the human subject) may produce sensor data from a wearable device, which can be evaluated during the physiological therapy session (operation 954). Also before or during the performance of this physiological therapy session, various therapy content may be received from an information system, which can be output during the physiological therapy session (operation 956).

Based on the wearable sensor data and the therapy content for the physiological therapy session, a status of the therapy activities by the user may be determined (operation 958). This status, such as an indication that the therapy is being performed correctly or incorrectly, the degree of activity exercise, or the number of repetitions, sets, or activities completed, may be used to customize the therapy content for the therapy session (operation 960). This customized therapy content may then be output to the human user during the therapy session, to provide real-time feedback and content (operation 962).

In connection with the methods depicted in FIGS. 9A and 9B, variations of adaptive therapy may be performed to customize therapies based on quality of therapy, quality of exercise, the quantity of exercises performed (or not performed) or like measurements or determinations. Accordingly, the therapy (and selected content and content delivery characteristics) may be customized based on current events, sensor data, and user activity history, preferences, and like inputs.

As an example, the information system may suggest a recommended exercise later in the day, based on how well or poor the prior exercise was earlier in the day. The use of adaptive therapy techniques, involve more than simple reminders based on time and predetermined direction; rather, the information system generates decisions and data customizations based on current events. Additionally, the information system is structured to ask prerequisite questions, send warnings and encouragement based on these measurements.

Based on these and similar workflows, different decisions and suggestions for therapies and treatments may be generated. Use cases for treatment based on physiological sensor data may include, determining how hydrated a person is, what the person's glucose level is, using next-generation physiological sensors, arid using collected data to help determine what therapy steps or activities should be conducted. Any number of motion (e.g., accelerometer, gyroscope, magnetometer) or, physiological (heat, moisture, light, sound, gas) sensors may be used to assist these inputs. Further different decisions for coaching or suggestions may be generated from such physiological sensor data.

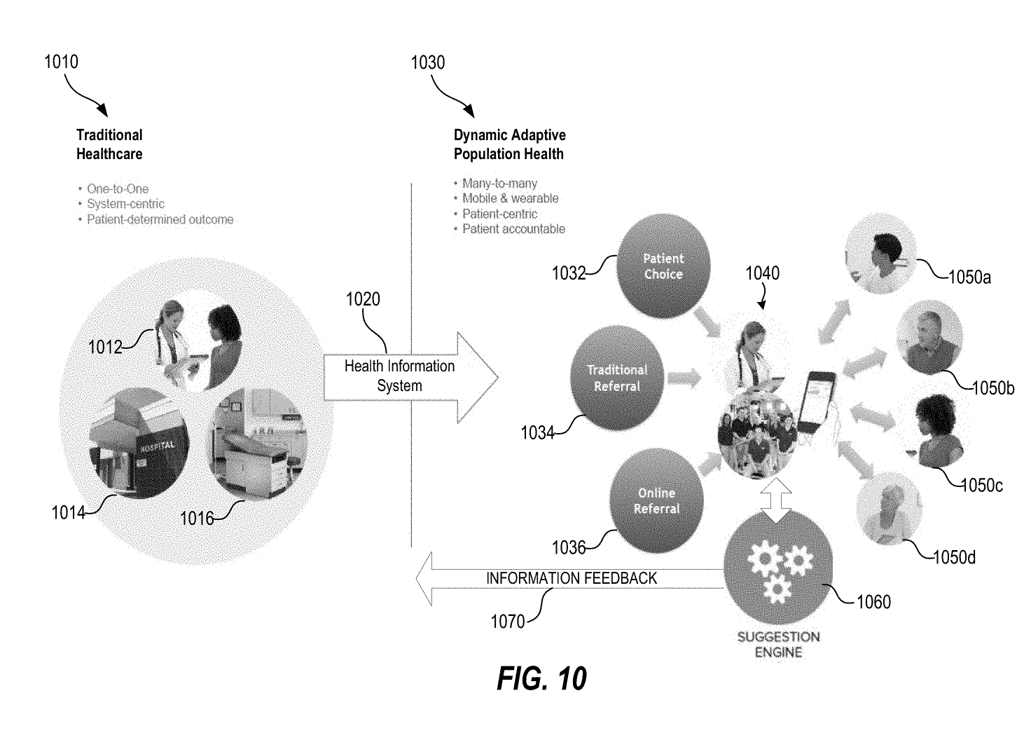

FIG. 10 illustrates relationships between entities in therapy and health monitoring environments according to an example described herein. As shown, FIG. 10 illustrates a contrast between the data that is collected in traditional healthcare environments 1010, with those enabled by the use of a health information system 1020 in a dynamic healthcare environment 1030 (commonly referred to as a “population health” setting). For example, the data that is collected in a traditional healthcare environment 1010 often includes a variety of one-to-one interactions, such in a physician and patient encounter 1012, a medical facility encounter 1014, and a clinical setting encounter 1016. In the traditional healthcare environment 1010, it is often up to the patient and the patient's personal motivation whether he or she will succeed with the therapy goals.

The health information system 1020 described herein is able to use the information from these encounters 1012, 1014, 1016 to compile and process useful therapy information for the assistance of a plurality of patients 1050a, 1050b, 1050c, 1050d. In the depicted dynamic healthcare environment 1030, the health information system 1020 is able to provide a network of inputs, outputs, and related electronic communications, using collaboration 1040 among healthcare providers, supporters, and electronic devices. This collaboration 1040 allows the use of therapy coaching and guidance in both traditional referral environments 1034 and online referral environments 1036, assisted by personalization from patient choices 1032.

The dynamic adaptive setting is able to provide operation through the use of the suggestion engine 1060 (e.g., an implementation of suggestion engine 204), which dynamically processes objective and subjective measurements, and generates push notifications, prompts, reminders, and other guidance to assist the performance of the therapy activities by the plurality of patients 1050a, 1050b, 1050c, 1050d. The information produced by the suggestion engine 1060 also may be used to assist the performance of traditional healthcare activities (such as through information feedback 1070), including providing guidance to physical therapists, overseeing activities and events for physicians, specialists, and other healthcare professionals.

The therapy workflow collaboration 1040 may include many-to-many interactions between multiple therapists, healthcare providers, supporters, and patients; the support data being collected and processed by mobile and wearable electronic devices; and the design of user interfaces and workflows to be patient-centric and emphasize patient accountability. The level of engagement resulting from the therapy workflow collaboration 1040 and the respective patients 1050a, 1050b, 1050c, 1050d enabled by the health information system 1020 thus can enable the performance of a variety of types of therapies, maintenance care, and medically-related activities, which are not enabled by a traditional healthcare environment 1010.

### Use of Content Suggestion Engine Operations and Electronic Information Systems in Therapy Applications

In addition to the techniques described above, the therapy and personal electronic device workflows may be implemented within an electronic information system driven by an adaptive content suggestion engine that suggests content relevant for therapy activities. The information system, as further described herein, may implement human interaction with a series of goal-based workflows and goal-based processing activities that deliver relevant content to encourage human activity and progress towards an ultimate goal (such as a therapy goal). Relevant content may be provided in a push or pull manner, on schedule or in response to determined conditions, and manually or automatically from the information system, in accordance with following techniques.

The computing systems and platforms encompassed by the present disclosure include a mobile or web-based social networking information service, interacting with a suggestion engine, which is used to motivate the human user to change behavior and perform activities through a persistent intelligent coaching model. The information service may provide intelligent decision making and reinforcement of certain content and content actions, to facilitate encouragement or motivation that increases the likelihood of desired human behavior to achieve the therapy goal (e.g., a therapy goal). In particular, the information service focuses on encouraging a human user to complete a series of discrete, separate actions or activities (small goals) that in combination will help achieve a larger overall goal. For example, in a physical therapy setting, this may include a series of tens, hundreds, or thousands of discrete actions that in combination will help the human user achieve a therapy goal.

Consistent with the techniques previously described, the wearable devices may e used to provide an ongoing monitoring data source, in the form of a measurable stream of data. This stream of data, which is dynamic in nature, provides far more specific information for therapy applications and therapy exercise than the type of data available to be collected in traditional medical treatment settings. Thus, wearable device data may extend therapy evaluation beyond the data that originates from laboratory testing, office evaluations, or physical therapy sessions.

Based on operations of the suggestion engine, the information service may adapt to learn a user's behavior patterns and offer personalized, relevant, or timely suggestions, motivations, or other directed content to help the human user achieve the therapy goal. The information service also may enable peer and professional support for a human user by creating and maintaining human connections relevant to the therapy goal, such as through establishing social networking connections and social networking interactions customized to the therapy goal. As the social network or the behaviors of the human user change, the information service may adapt to alter the actions, motivations, or other directed content to remain relevant, personal, or timely to the human user. In this fashion, the information service is intended to cause behavior changes of the human users, through promotion to achieve the user's therapy goals with social encouragement by friends, family, or team members (supporters), personal motivations reinforced with reminders, or new structures in their living environment, such as may be helpful in altering habits to achieve the goal.

For example, in a physical therapy setting, the suggestion engine may be used to help pick from predetermined list of suggestions that are more appropriate for certain users or user activities, based on adaptive data input to the engine received from the wearable devices. The suggestion engine is also involved in monitoring progress towards the therapy goal, over time. As a result, the suggestion engine can “close the loop” with patient interactions to allow useful medical outcomes.

The information service may include various applications and corresponding user interfaces to be viewed by the human user and supporters of the human user to encourage beneficial interactions between the human user and the supporters. These interactions, which may be driven by suggested content and suggested content delivery types or timings, can cause activities that lead to the intended behavior change(s) in a human user. Accordingly, the content suggestion engine acts in a larger environment of an “intelligent” information system that provides appropriate messages and content selections to the human user and supporters at the right time, to encourage therapy activities.

The content suggestion engine techniques and operations described herein may also incorporate a variety of machine-learning and artificial intelligence concepts to adapt to contextual information (such as feedback and detected activities), and deliver therapy-based content to the human user 106 using appropriate timings and mechanisms. As the health information system 102 (and its content suggestion engine) produces suggested actions and obtains patient feedback, the health information system 102 can start to learn what is successful, and apply greater weight to a particular suggested action with a higher likelihood to succeed, thereby producing a cycle of improvement with a greater likelihood of progress towards therapy goals.

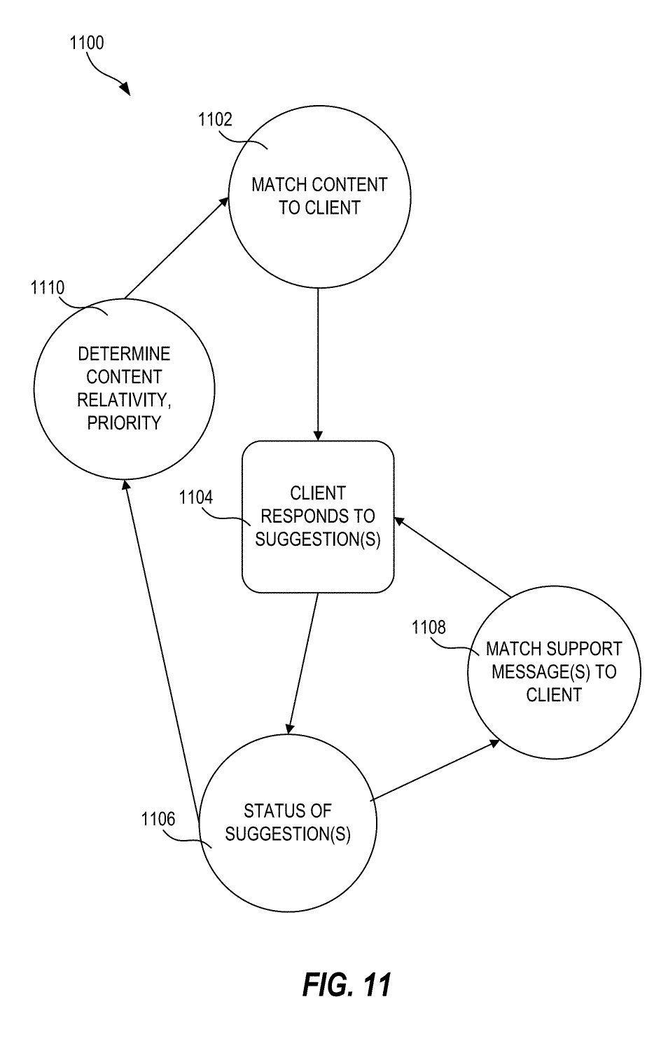

FIG. 11 illustrates an example technique 1100 of patient interactivity with a suggested therapy action (e.g., an exercise recommendation) generated from the health information system 102. At operation 1102, content can be matched to the human user 106, such as through data processing techniques, and filtering and weighting techniques. At operation 1104, the human user 106 can respond to the suggested action, such as by accepting or rejecting the suggested action message. A no-response within a period of time may also serve as a response. At operation 1106, the status of the suggested action can be determined, such as determining if the suggested action message was accepted or rejected, or when the suggested action message is accepted and whether the action in the suggested action message is completed or not (including using wearable sensor data to determine compliance). At operation 1108, a support message can be sent to the human user 106, such as sending the human user 106 an encouraging or motivating message to try to get the human user 106 to complete the action.

At operation 1110, content relativity, priority, and other content delivery metrics can be determined, and such metrics can be recorded for use in the delivery of a future suggested action. For example, higher weights may be associated with certain types of therapy activities, so that additional (or a higher frequency) of certain exercise suggestions will be returned to a user in response to real-time data from the wearable device. The wearable device data thus provides a new class of objective data that can be used to drive not only which content is selected, but how and when it is delivered.

If questionnaires, psychological profiling, or data collected from the wearable device indicates that a problem exists in an area that is different from the therapy goal(s) created by the human user 106, then the system can ask the human user 106 to review the goal(s) or suggest the human user 106 add another goal and indicate what that goal is. The system may also encourage the human user 106 to achieve the goal by providing reward points (e.g., kudos), other incentives, and encouraging content outputs.

A new patient also can choose a program from a group of pre-created programs. These programs can include suggested actions that encourage the human user 106 to achieve therapy goal(s) and related therapy activities, encourage the patient to perform suggested actions that help them learn the different features of the system, record how the human user 106 uses the system, and suggest that the human user 106 complete questionnaires, at intervals or regularly. Obtaining feedback on a suggested action can help the suggestion engine 204 determine which suggested action to recommend to the human user 106 after the program is complete.

Therapy actions and accompanying content may be selected based on a therapy plan or progress towards a smaller or larger therapy goals. Based on the plan and the goal, completed suggested actions can be withheld from subsequent retrieval from the suggested action database for a specified period of time. This delay can be based on a user preference, such as the human user 106 indicating that they prefer variety or sameness in the suggested action messages that are presented to them. For example, if a human user 106 indicates that they prefer variety, a completed suggested action can he withheld for a longer period of time than if the human user 106 indicates they prefer sameness.

A therapy goal can be said to be accomplished when the human user indicates the goal has been accomplished or when the system determines that the goal has been accomplished. For example, the system can ask the human user 106 or the human user's supporters if the goal has been accomplished.

A human user 106 can indicate that the suggested action was not timely, or was unhelpful/painful. In such situations, the system can ask the human user 106 when the suggested action message would be (or would have been timely), or what portion of the therapy action caused issues. A timing related to a suggested action message can be adjusted accordingly. Timing attributes (e.g., provided in a “tag”) can indicate an amount of time that the human user 106 can be given to complete the task or set of tasks, such as 15, 30, 45, 60 minutes, or the like. Sensor data from wearable devices may be used to monitor compliance with the tasks.

The difficulty rating (e.g., provided in a tag) of a suggested action can be altered in accordance with user feedback. The weight of a suggested action can be altered as a user's ability to complete a type of suggested action changes. For example, if a human user 106 rates a suggested action as too hard or painful, the weight of the suggested action can be decreased, and the weight of suggested actions with lower difficulty can be increased.

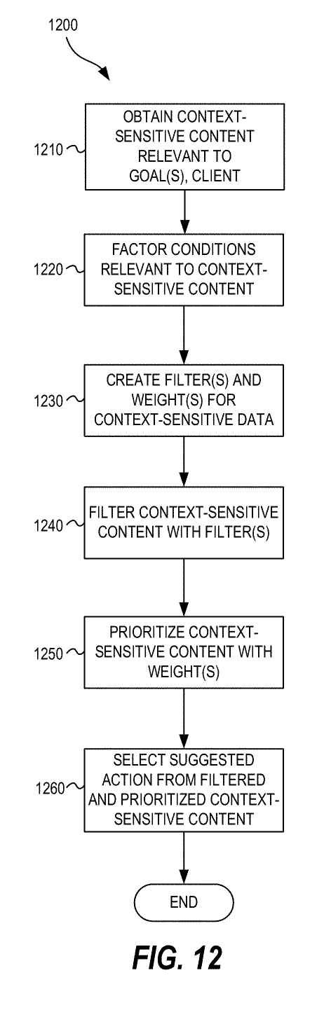

FIG. 12 illustrates a flowchart 1200 of an example technique performed by a suggestion engine (e.g., suggestion engine 204) for determining suggested content from an information system (e.g., the health information system 102 illustrated in FIG. 1). At operation 1210, context-sensitive content can be obtained. The context-sensitive content can be relevant to the human user 106 (e.g., personality type, barriers, incentives, contextual information, data) and the therapy goal(s) of the human user 106. At operation 1220, conditions relevant to timing, delivery, access, or use of the context-sensitive content can be evaluated (such as from data values or data processes 108 specific to the human user 106). At operation 1230, filter(s) and weight(s) can be created. The filter(s) and weight(s) can be created as a function of the user's likes, dislikes, barriers, incentives, goal(s), personality type, data, or a combination thereof, among others. At operation 1240, the context-sensitive content can be filtered, such as by filter(s). At operation 1250, the context-sensitive content can be prioritized, such as by weight(s). At operation 1260, one or more suggested actions can be selected from the filtered (operation 1240) and prioritized (operation 1:250) context-sensitive content.

Context-sensitive content relative to a goal can be experiential data (e.g., data learned through the user's interactions with the system or wearable device measurements). The human user 106, the user's goal(s), and the weighted and filtered context-sensitive content can each include their own corresponding matrices. At least one suggested action message to present to the human user 106 can he selected through mathematical operations including these matrices, such as finding a minimum distance between matrices, multiplying, adding, subtracting, inverting, or performing other such operations on the matrices. Feedback received from the human user 106 can he factored into a matrix so as to change the outcome of the mathematical operations and provide suggested actions that are better suited for the human user 106 or the therapy goal or therapy activities.

Individual suggestions and suggested actions may be linked together to create playlists or programs. For example, as a comparison to a chemistry-like composition, just as atoms are organized together to create molecules and molecules strung together to create large structures with a specific purpose, individual suggestions and playlists of suggestions combine to create programs with a unique purpose and flavor. In this fashion, dynamic therapy programs may be launched and controlled.

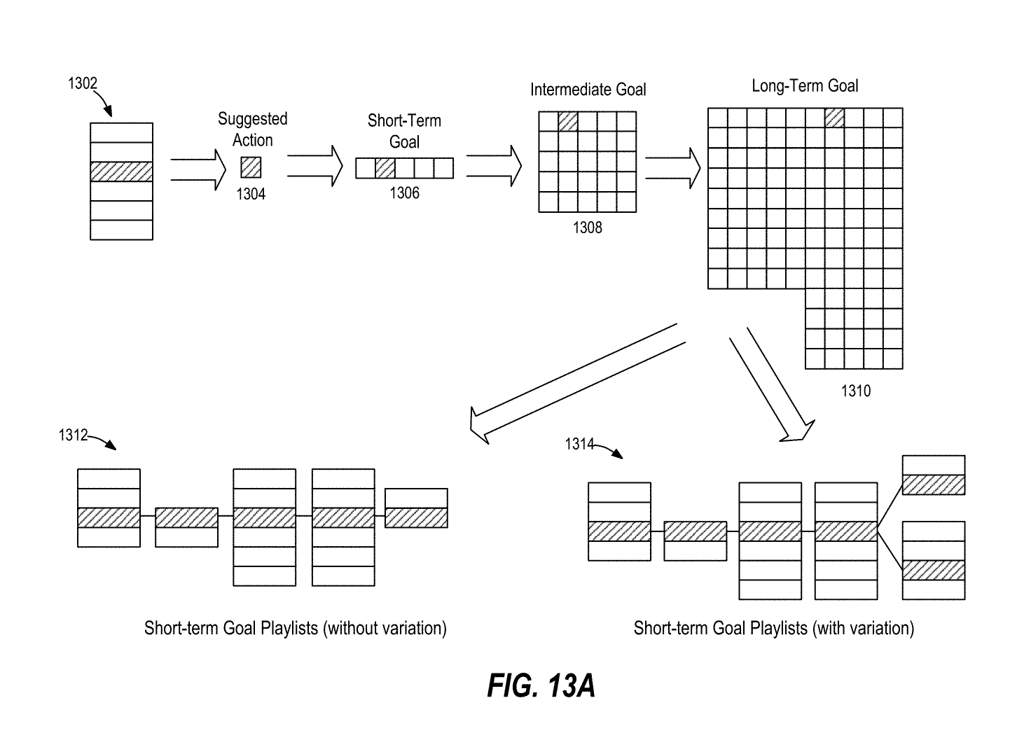

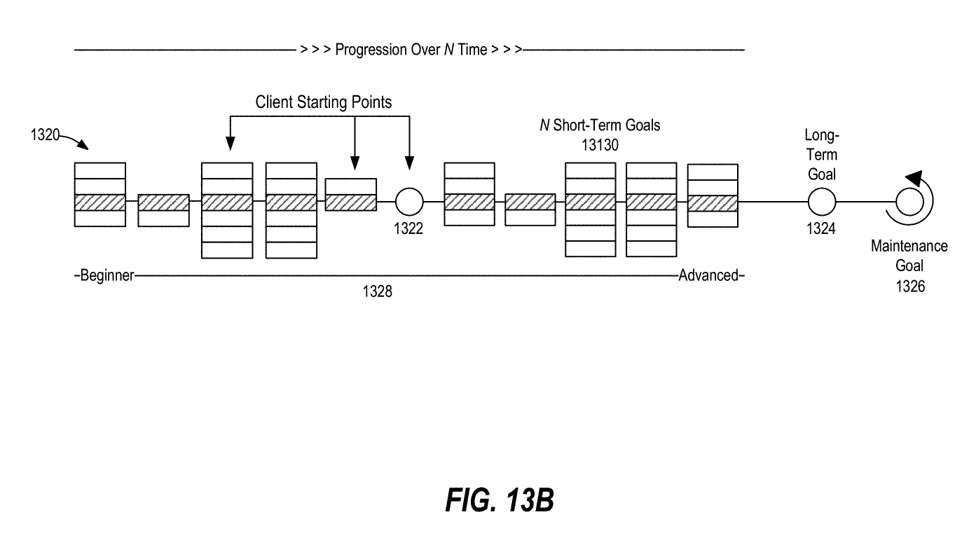

FIG. 13A illustrates the concept of various suggested action(s) included within goals, goal programs, and playlists of goals. A playlist (e.g., playlist 1302) is a set of suggested actions (each suggested action being introduced to the user through suggested content) that may be presented to the human user 106 as a single “set of suggested actions”, individually or as part of a short-term goal 1306, intermediate goal 1308, or long-term goal 1310. Providing a playlist can make user actions to choose or select actions less frequent, and provide a short term context for the human user 106. The human user 106 may want repetition, variety, to concentrate on a particular area, to see progress in a particular area, or to be generally healthy. Playlists may be designed to link suggested actions together to create a coordinated effort that may consider the desires of the human user 106.

The, playlist 1302 may be chosen as a specific item by the human user 106. The playlist 1302 may include suggested actions over a period of time, such as a day, week, ten days, months, quarter, year, etc. The human user 106 may wish to choose a (somewhat) coordinated effort that is longer than a single action. For example, making sure they eat a healthy breakfast for one week. The playlist feature may allow the human user 106 to choose this as a single item. Each suggested action 1304 in the playlist may be set for specific times as designated in the playlist (e.g., every x period).

A playlist may be linked as part of a larger program. A program can be: 1) a designation of a specific type of suggested action 1304 by keywords, where the suggestion engine 204 preferentially chooses actions or playlists to present to the human user 106 as a function of the keywords; or 2) a set of playlists presented in a series, such as a series that has a defined objective.

For programs of the first type, the human user 106 may be offered the option of choosing a program to follow. For programs of the second type, professional users, such as employees or professional therapists, can create programs by selecting a series of playlists, and then giving a definition, keywords, or additional attributes to be included by the program. The program may include a “creator” designation for the user who created the program and the “creator” may title the program. Choosing a program may give the human user 106 context for why they are doing the specific eating/movement/self-view suggested action(s) 1304.

Supporters may quickly organize suggestions and suggested actions 1304 into unique content playlists 1302 that are targeted towards groups of users. Playlists may be short or long (one day or one week), generic or commercial program. A generic eating program might be following a low carbohydrate, low fat, or low calorie diet versus a commercial weight loss or diet. The health information system 102 may allow the human user 106 to follow their desired type of playlist for their custom environmental goal based on their structured data profile settings or other data input.

An environmental or specific goal set by the human user 106 can be a powerful motivation. The goal may be used to determine what percentage of suggested action messages will be, for example, in each of the eating/movement/self view areas. The goal may be used in motivating the human user 106 by reminding them of the goal they have chosen.

As depicted in FIG. 13A, short term goal playlists 1312 may be established to be predetermined without variation, upon the establishment of the playlist. The short term goal playlists 1312 may vary in the number of suggested actions over time, and retain a link between common suggested actions. Short-term goals may be strung together based on difficulty rating, or on other ratings for the appropriateness of the specific suggested action(s). The same short-term goal (or a set of playlists for suggested actions) may also be repeated at appropriate times.

As also depicted in FIG. 13A, short term goal playlists 1314 may be configured with variation based on user input, user responses, user preferences, or other factors. For example, the short term goal playlists 1314 may provide a branching opportunity to choose one sub-playlist of suggested action if a certain suggested action is performed; if the suggested action is not performed or does not achieve certain results, then another sub-playlist of suggested action may be chosen. As such, the path an individual users takes to get to his or her long-term goal is unique, with n-number of short-term goals, and a variable amount of time.

The suggestion engine 204 may deliver appropriate suggested action content separately or in connection with the playlist(s) to the supporter network 110 or human user 106 as a function of a set of rules. These rules can include how the content will be delivered to the human user 106 or the supporter network 110. The suggestion engine 204 may determine one or more suggested action message or playlists based on the user's psychological, lifestyle, or preference and restriction assessment, or the user therapy goal(s). The suggested action message may be sent to the supporter for forwarding on to the human user 106 or directly to the human user 106 depending on rules or preferences.

FIG. 13B provides an illustration of a series of playlists 1320 for a particular human user, having a progression of suggested actions linked during a period of time N towards completion of an intermediate goal 1322, completion of a long-term goal 1324, arid performance of a maintenance goal 1326.

The user's starting point along the timeline 1328 may be dependent on an experience scale and certain assessments. Such assessments may be conducted to measure progress and receptivity to performance of the overall goal or time-based goals, arid the overall execution of the playlist or progress along the experience scale. The assessments may be derived from questions based on general intentions of an initial assessment result, or may be derived according to a specific plan. A human user 106 may be considered a “beginner” or low-skill in some areas or activities but not others. The information system may attempt to factor multiple areas when measuring overall progress, to ensure multidimensional attention to different areas of progress and concern.

The progression over N time along the timeline 1328 may result in changes to communications and results of the workflow. For example, less interaction (e.g., delivered reminders) may be sent the closer that the human user 106 advances to achieving the long-term goal set by the human user 106 for a certain date. Upon completion of the long-term goal 1324, a maintenance goal 1326 may be established. A maintenance goal 1326 may be used to reinforce certain behavior through less interaction. A maintenance goal 1326 may be used where the human user 106 does not necessarily need to “make progress” but would like to continue beneficial therapy activities.

The content provided by the goal-based workflows may follow a general flow. The human user 106 may be presented with a number of suggested action messages (or playlists 1320), from which they may choose one or more activities. Messages for the suggested action 1304 may be presented as just the action statement with no personalization. A timer of a specified period, such as one hour, twenty-four hours, or the like may begin at or around the time the suggested action 1304 is chosen. The suggested action 1304 may have a designated time of day associated with a therapy session; when the human user 106 has not set preferred times when choosing a suggested action, the system may ask the human user 106 when they typically perform the therapy action.

One or more reminders may be sent to the human user 106 in connection with the goal-based workflows. The reminder may include personalization—the reminder may be provided at the beginning of the next day, or at or around the time the designated time arrives. A motivation or prompt may be sent to the human user 106 at times before or after the reminder. A prompt may be sent to the human user 106 after the specified period of time has lapsed. This prompt may ask the human user 106 if they have completed the suggested action. If the human user 1.06 has completed the suggested action, they may be rewarded with reward points (also referred to herein as “kudos”) given a congratulatory motivation. If the human user 106 has not completed the suggested action, they may be given a conciliatory motivation, such as “you will get it next time!!” The human user 106 may be asked if: 1) they would like to try again; or 2) move on to the next suggested action, or something similar. If the response is to try again, the previous action may be presented at the appropriate time with appropriate motivations and prompts; and if the response is to move on, the system may log the incomplete suggested action as not completed and send the human user 106 to the next task. If the human user 106 has chosen a playlist of suggested action messages, the steps above may be substantially followed, such as without the human user 106 being asked if they would like to try again. If the human user 106 does not perform a suggested action they may be presented with a conciliatory motivation, and then reminded of the next task in the play list. When a human user 106 is sent a suggested action message from a playlist, the playlist name, or the order of the suggested action message may be included in the information available to the human user 106.

After the human user 106 has engaged with a suggested action, the system may provide an appropriate motivation, prompt, reminder, or reward statement. The number of motivations, reminders, and prompts may be defined in a suggestion engine 204 database, and may be based on the user's psychological assessments. A psychological assessment may include determining a receptivity of the human user 106 to a motivational or encouraging statement, such as whether the human user 106 is a caregiver, colleague, competitor, or authoritarian; a user's engagement in achieving their goal, such as whether the human user 106 is an optimist, fatalist, activist, or skeptic; a user's social style, such as whether the human user 106 is a driver, amiable, analytical, or expressive; or a combination thereof. For example, a message for a caregiver may take the form of admonition, can communicate to the human user 106 that the substance of the message is good for them, or be supportive yet direct. Such persons may tend to assume a hierarchical relationship in which they have sonic form of power over another, yet tend to be more challenging than nurturing in their interactions. A message for an optimist may include encouragement to act, support or pressure from their social network, increasingly persistent reminders to act, or a combination thereof. Such persons tend to think about the suggested action, search for ways to ensure success, overthink or overplan, or have a high level of excitement that may diminish without action. A message for an analytical person may include statistics or data that provide support for why the action should be accomplished, or it may be more task-oriented than person oriented. Such persons may be perfectionists, critical of themselves, systematic or well-organized, prudent, or a combination thereof.

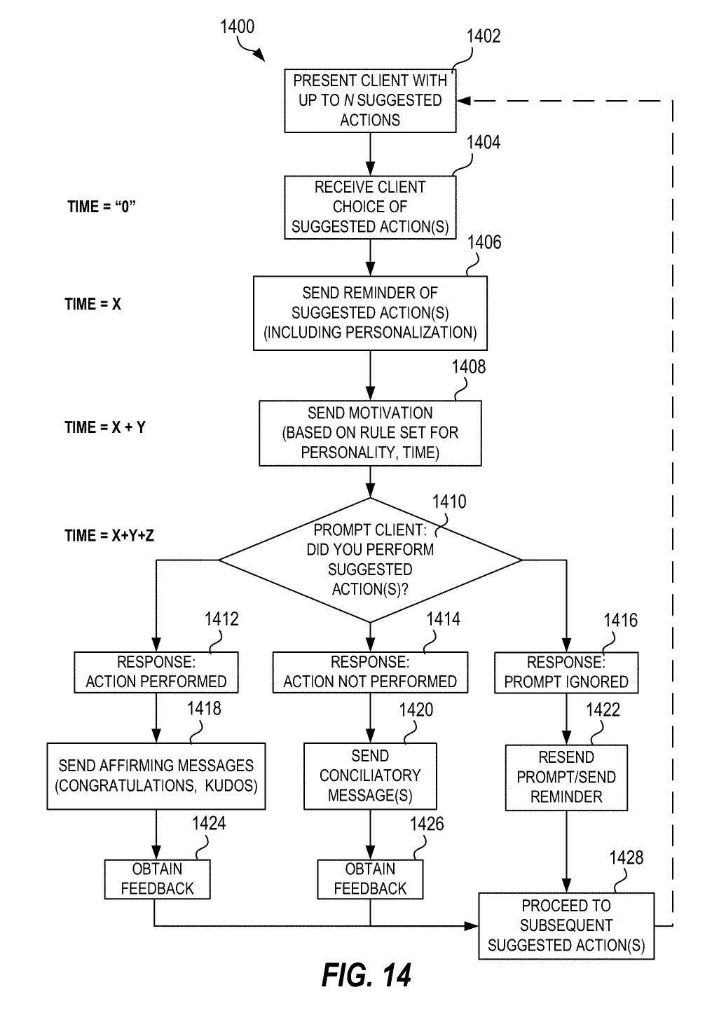

The delivery, presentation, and response mechanisms for providing suggested content and suggested actions may be provided in a linear process to encourage action and appropriate feedback. FIG. 14 provides an illustration of a technique 1400 for delivering suggested actions and obtaining feedback from human users according to an example.

At operation 1402, a human user 106 can be presented with up to N suggested actions, such as for the presentation of respective therapy activities. The suggested actions can be chosen using data processing techniques, or filtering and weighting techniques. At operation 1404, the system can receive the user's choice or input for the suggested action(s). At operation 1406, the system can send a reminder to the human user 106 that the chosen suggested action should be accomplished. At operation 1408, a motivating message can be sent to the human user 106. The motivating message can be configured as a function of the user's personality type, the goal(s), the time frame which the human user 106 set to accomplish the goal, or other data or context information.

At operation 1410, the system can prompt the human user 106 to indicate whether they have performed the chosen suggested action or not. There are at least three responses the human user 106 can provide. In another example, this response data may be determined from automatically from the wearable device data (including a measurement of whether the suggested activity was complied with).

In one scenario, at operation 1412, the human user 106 can respond that the suggested action was performed. At operation 1418, the system can send an affirming message (e.g., a congratulations or kudos) to the user. At operation 1424, the system can obtain feedback from the human user 106, such as by asking the human user 106 questions about their experience in performing the suggested action.

In another scenario, at operation 1414, the human user 106 can respond that the suggested action was not performed. At operation 1420, a conciliatory message can be sent to the human user 106 from the system. At operation 1426, the system can obtain feedback from the human user 106, such as by asking why the suggested action was not completed.

In another scenario, at operation 1416, the human user 106 can respond by ignoring the prompt. At operation 1422, the system can resend the prompt, send a reminder that the suggested action should be performed, or present a different set of suggested actions, such as at operation 1404.

Regardless of the response received from the human user 106, the system can proceed to present subsequent suggested actions at operation 1428 (e.g., the process can start over at operation 1402).

The health information system 102 may provide various features and functions to assist data collection and content delivery. This may provide a professional user with the ability to control multiple aspects of the goal-based workflow and goal-based interactions, including when particular content is delivered to a user, and the defined triggers to provide such content. The professional user may also utilize the health information system 102 to provide communications over a variety of mediums, enabling the professional user to chat, send images, send videos, monitor the member, and provide suggestions (including through multimedia, URLs, timing components, and the like).

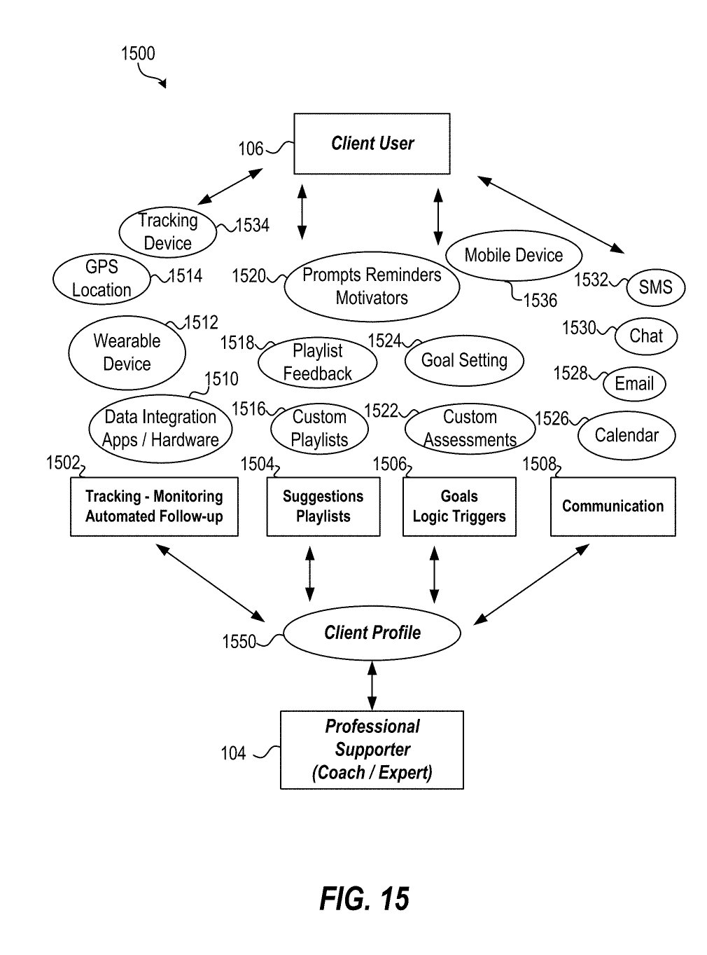

FIG. 15 provides an illustration of member profile information and supporter coaching tools 1500 used in connection with expert-based content selection and delivery techniques of the health information system 102. As shown, a professional supporter (the therapist 104, a coach, expert, or other professional user) accesses a user profile of the information system (e.g., member profile information) to utilize various tools and functions for encouraging therapy activities (for example, to convey information and activity information towards the client user, the human user 106).

In a first example, the information system may utilize information in the user profile 1550 obtained from wearable devices to provide tracking, monitoring, and automated follow-up on suggestions 1502 for delivery to the human user 106. The tracking operations may be provided through interfaces to other technologies, and data integration with various software applications and hardware devices 1510, including with the use of other types of electronic devices not specific to the therapy activity. One example hardware device is an exercise tracking device 1512 configured to track daily activity (e.g., tracking a user's walk using an accelerometer, pedometer, GPS, and the like). The user's GPS location 1514 may provide further information on the habits of the user and the user's habits, likes, and amount of activity. In other examples, the data integration may occur through a customized app running on the user's smartphone (e.g., mobile device 1536). Other tracking devices 1534 including medical devices (e.g., wearable devices as discussed above) may be used to collect and provide relevant tracking and monitoring data.

In a second example, the information system may utilize information in the user profile 1550 to provide suggestions and playlists 1504 to the human user 106. This may be, provided by pushing suggestions through other supporters, attempting to leverage other relationships to communicate information through the user's existing supporter relationships. For example, custom playlists 1516 may be established to provide custom information from the professional supporter to the user. The user may provide feedback and compliance information back to the professional supporter through the use of playlist feedback 1518. This interaction may be provided through the communication mediums described herein, for example, the mobile device 1536.

The suggestions and playlists 1504 may be integrated with various prompts, reminders, and motivators 1520 to deliver the content to the human user 106. For example, custom playlists 1516 may include therapy activity suggestions that are triggered by logic based on various inputs including the custom assessments 1522 and the goal setting 1524. The prompts, reminders, and motivators 1520 may be associated with custom responses defined by the professional supporter, including specific actions to respond to user behavior.

In a third example, the information system may provide mechanisms to manage goals, logic triggers, and like conditions 1506 from the user profile 1550, related to use of the goals. For example, the custom assessments 1522 may provide questionnaires to determine the current state of the user. These mechanisms may also be integrated with goal setting 1524 (which may be referred to as a “Destination”) and automated tracking of user's progress towards the goal.

In a fourth example, the information system may provide various communication mediums 1508 to facilitate communication between the professional supporter and the human user 106, based on preferences and settings in the user profile 1550. These may include SMS 1532, chat 1530, email 1528, calendar integration 1526 (e.g., to schedule in-person meetings and to integrate to other calendar services), phone communications, or communications through interfaces to the health information system 102. In addition, communication may include prompts (providing a two-way communication eliciting response from the user) or a “sales representative”-type call for inquiries on the status of the user.

The supporter coaching tools 1500 may be used to provide a professional user/expert such as the therapist 104 with access to scalable client base in need of their expertise. A therapist 104 may choose to build teams of clients that they are suited to help, and send playlists to clusters of networks, rather than reaching out to individual clients. In addition, the therapist 104 may be able to provide similar or the same content playlists to groups of users, receiving ratings and feedback to determine which users are most receptive to the coaching and content.

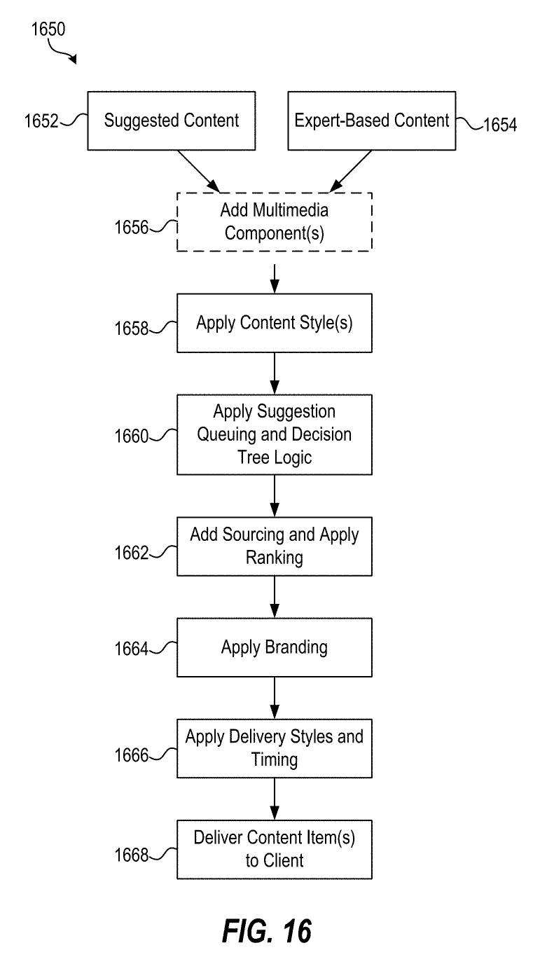

FIG. 16 provides an illustration of data operations 1650 occurring in the generation and use of expert-driven content playlists in the health information system 102 according to one example. The playlist may be created from one or a combination of suggested content 1652 originating from the health information system 102, or expert-based content 1654 originating from the professional supporter or user (e.g., the therapist 104). The suggested content 1652 may also include components of crowd-sourced content such as member-provided or group-provided content. The health information system 102 may prompt, suggest, or encourage the generation of the expert-based content, and allow the expert to change portions of the suggested content.

Upon the definition of the content, the professional supporter may apply his or her coaching style through the use of templates and various tools. These include having the expert choosing to add multimedia components (operation 1656). Suggestions may contain one or more of the following, for combination into a playlist for the member: Videos; Music (e.g., MP3) files; Picture files: Animated picture files; Coaching voiceover and integration to music libraries and services; Quotes; Event invitations; Textual Content; or External URL content.

The content may be refined further by applying one or more content styles (operation 1658). The applied styles may include aspects of (or be chosen based on): profile types, geographic location, culture, or environment, as some example.

The content may be refined further by applying suggestion queuing and decision tree logic (operation 1660). Such logic may provide the ability to: change a variable countdown timer used for delivery or use of content; change duration, difficulty, and frequency of suggestions (intensity); provide reminders, motivators, and prompts based on trigger logic; and maintain a content audit trail for verification.

The content may be refined further by applying sourcing and ranking (operation 1662). The sourcing and ranking may provide the ability to add and cite information sources such as: clinical pathways; therapy programs; exercise regimes; or other affliction-specific content.

The content may be refined further by applying branding (operation 1664). Branding capabilities provide the ability for a professional user to add: a logo; background signature sound; biography; listing of publications or books; or otherwise provide the ability to post specific content to users.

The delivery styles and timing of the content may also be changed or defined (operation 1666). Professional users can use all feature controls of specific mobile devices (e.g., iOS versus Android, utilizing features such as speakers, sound, flash, vibrate) with the delivery of content. Other examples for use by a professional user may include: sending a SMS message in all-capitalized letters; vibrating the phone and using a camera flash; playing a soft noise such as a relaxing waves sound: playing a loud noise such as bowling pings crashing; changing phone wallpaper; making a call to supporter; or performing an automated follow up call to the user.

As a result of the preceding refinement operations, the items in the expert-driven content playlists may be delivered to the human user 106 (operation 1668). The professional user may be provided with additional controls and opportunities to further customize or shape the content, similar to the preceding operations.

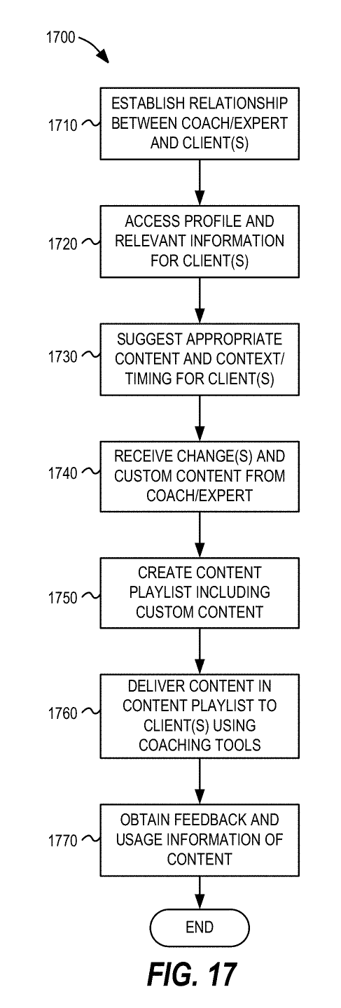

FIG. 17 illustrates a flowchart 1700 of an example implementation method of providing expert-based content and coaching from a professional user to a particular user or set of users using the health information system 102 according to an example described herein. The particular sequence depicted in the flowchart 1700 is provided as a non-limiting example, and illustrates a workflow involving a relationship between a coach/expert/other professional user and one or more users. Other aspects of the workflow may include interactions with the previously described information system and associated databases and graphical user interfaces, with individual or groups of users.

The flowchart 1700 illustrates a series of operations including establishing a relationship between the professional user and one or more users (operation 1710). The coaching operations may be assisted by accessing profile and relevant information for the one or more users (operation 1720). From the profile and relevant information, the health information system 102 may suggest appropriate content and content or timing for the one or more users (operation 1730).

The professional user will provide changes and custom content to the information system (operation 1740). The health information system 102 will use these changes and custom content to create a content playlist for the particular user(s) being coached by the professional user (operation 1750).

The health information system 102 will deliver the content in the content playlist to the user(s) using coaching tools and various delivery mechanisms enabled by the information system (operation 1760). The health information system 102 will then obtain feedback, responses, and other usage information of the user (operation 1770), for example to provide a response on the effectiveness of the coaching back to the professional user.

Although some of the previous examples were provided with reference to specific medical conditions and therapy activities, it will be understood that the applicability of the present system may apply to a variety of human behaviors and goal-based activities in medical and non-medical settings. A non-limiting, illustrative listing of the applicability of the present techniques to medical conditions includes weight loss, smoking cessation, addition recovery, chronic illness management, psychological support, and the like. Another non-limiting, illustrative listing of the applicability of the present techniques includes application to non-medical settings such as education and learning, sport activities and sports training, and other scenarios where human activity is correlated to some goal or achievement.

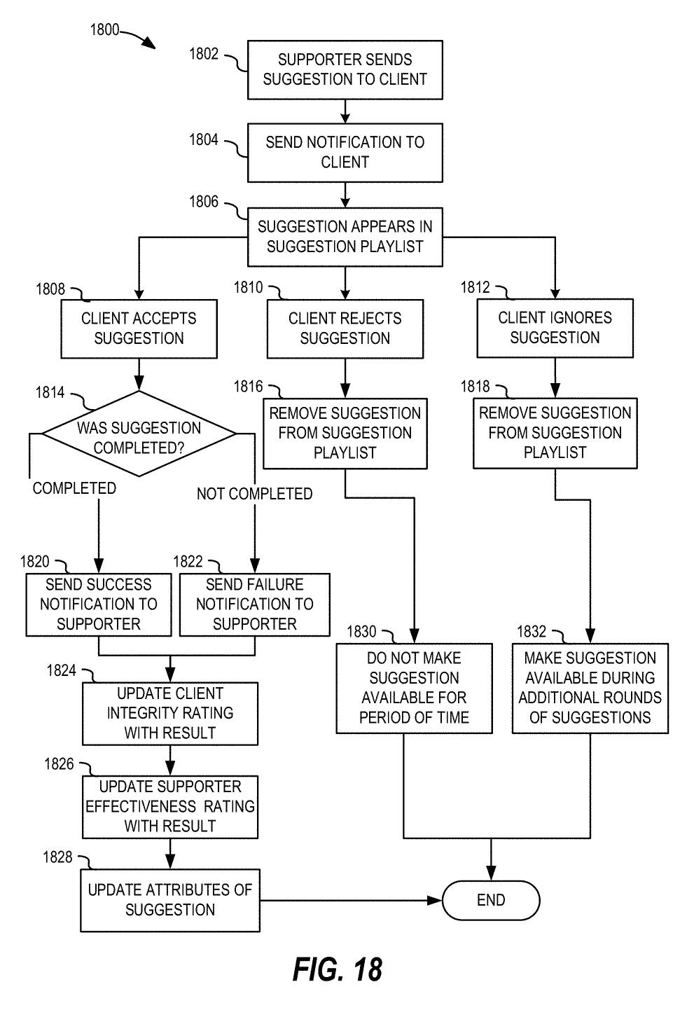

FIG. 18 illustrates an example technique 1800 of processing user interaction with suggested actions of a therapy activity, in a suggestion playlist for a goal-based therapy workflow according to an example described herein. First, a supporter may send (e.g., forward) a particular suggestion to a human user 106 (operation 1802). A notification of the particular suggestion may be sent to the human user 106 (operation 1804). The notification may indicate that the suggestion has been sent to the human user 106. The suggestion may appear in a suggestion playlist for the human user 106 (operation 1806).

At this point the human user 106 may take one of at least three actions: 1) the human user 106 may accept the suggestion to make the suggestion part of the playlist (operation 1808); 2) the human user 106 may reject the suggestion and refuse to perform the suggested action in the suggestion (operation 1810); or 3) the human user 106 may ignore the suggestion and not do anything with regard to the suggestion (operation 1812).

If the human user 106 accepts the suggestion, it may be determined if the suggestion was completed (decision 1814), such as by asking the human user 106 if they completed the suggestion, or evaluating wearable device data to determine whether the suggested activity was completed. If the suggestion was completed, then a success notification may be sent to the supporter who sent the suggestion (operation 1820). If the suggestion is not completed, then a reminder may be sent to the human user 106 or a failure notification may be sent to the supporter who sent the suggestion (operation 1822). A user integrity rating may be updated in accord with the result (whether or not the human user 106 completed the action) (operation 1824). A supporter effectiveness rating may be updated with the result (operation 1826). Various attributes (e.g., difficulty, helpfulness, timeliness) of the suggestion also may be updated (operation 1828).

If the human user 106 rejects the suggestion (operation 1810), the suggestion may be removed from the suggestion playlist (operation 1816) and the system may prevent the suggestion from being suggested again for a period of time or indefinitely (operation 1830).

If the human user 106 ignores the suggestion, the suggestion may be removed from the suggestion playlist (operation 1818) and the suggestion may be made available for the next, or a subsequent round, of suggestions (operation 1832), or the system may prevent the suggestion from being suggested again for a period of time.

A reminder may be provided to the human user 106 regarding the suggestion. The reminder is a message from the health information system 102 that is sent at a time between when a suggested action is accepted or ignored and when their suggested action is completed. A reminder can take the form of a calendar reminder. Reminders may be configured as a function of a category that the suggested action belongs to, such as eating, movement, or self view. In some examples, a self-view suggestion may be accompanied by a reminder to complete the action about 6 hours before the suggestion may be completed. In sonic examples, a suggestion may be accompanied by a reminder that is sent to the human user 106 about a half-hour before a scheduled activity time. In some examples, a movement suggestion may be accompanied by a reminder that is sent to the human user 106 about 12 hours before the human user 106 is to complete the suggestion. Other notifications may be sent to the human user 106 or other users of the application. A notification may be a “call to action” that directly impacts the human user 106, a supporter in the supporter network 110, or a dual role user regarding their support network, progress, account settings, subscription, or other miscellaneous items.

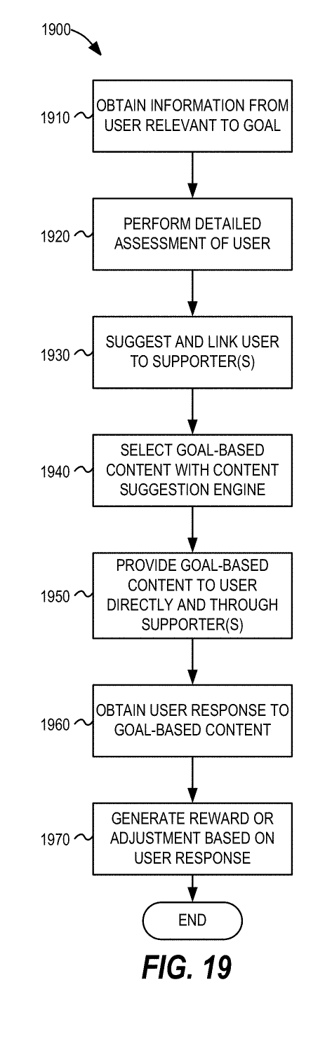

FIG. 19 illustrates a flowchart 1900 of an example implementation method of a goal-based workflow for effecting therapy activity using the health information system 102 according to an example described herein. The particular sequence depicted in the flowchart 1900 is provided as a non-limiting example, and illustrates a workflow involving an initial content selection and content display. Other aspects of the workflow described herein may include other portions of interaction with the information systems and associated graphical user interfaces.

The flowchart 1900 illustrates a workflow of information system operations originating with various data collection operation steps. These data collection steps are designed to continually adapt and learn from users, considering the current state or mood of the user, while refreshing data stored in the system as appropriate. The data collection steps may include obtaining information relevant to goal from a user (operation 1910) and performing a detailed assessment of the user (operation 1920). The information relevant to the goal may include a self-selection of the overall goal or goals, or other mechanisms such as questionnaires to filter the goal. The detailed assessment may include a psychological assessment or other profiling assessments.

The information system may operate to suggest one or more supporters, and link the user to the suggested supporters (operation 1930). The supporter link may be created in response to user acceptance provided with automatic criterion or manual selection.

The content for the user from the information system may be selected and delivered, through operations to select therapy-based content with a content suggestion engine (operation 1940), and provide the therapy-based content to the user directly or through one or more supporters (operation 1950).

The response to the content (including any suggested action and the results of the response to the suggestion action) may be obtained from the user (operation 1960). Based on the user response and the particular action performed or not performed, a reward or adjustment may be generated in the information system (operation 1970). This may include the refinement of content and suggested action selections (and the exclusion of particular suggested actions).

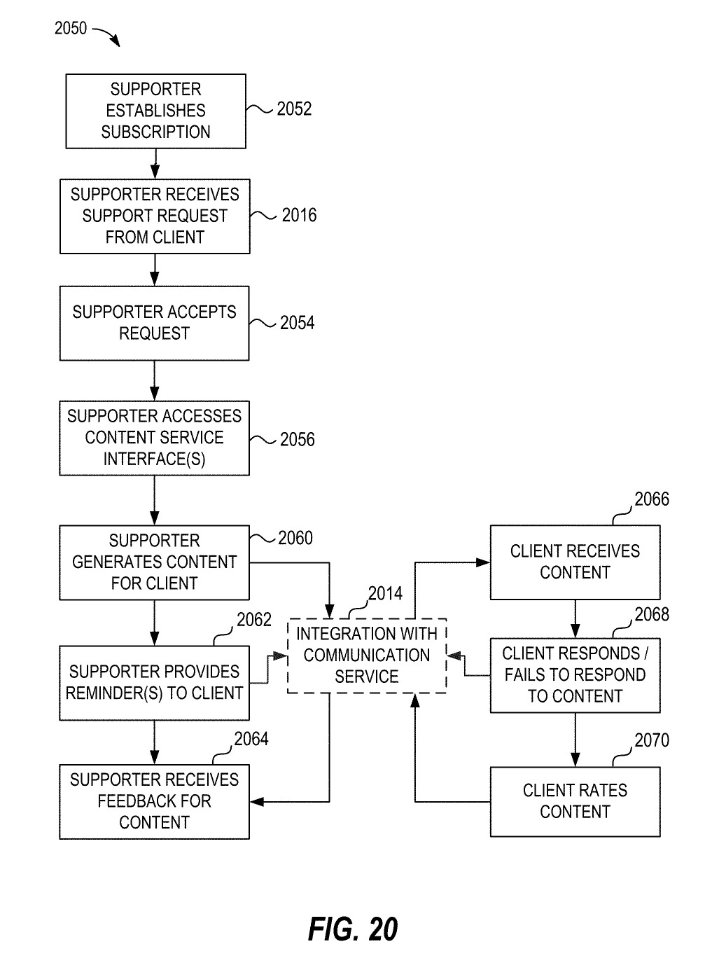

FIG. 20 illustrates a flowchart 2050 depicting a workflow for supporter interaction within an information service providing a software or other user-interactive application for users and supporters. Flowchart 2050 illustrates operations to generate content for communication from supporting users such as friends and social network connections to supported users, to encourage therapy activities by the supported users.

In the workflow, a supporter may establish a subscription to the application (operation 2052). This may be accomplished by visiting a website or purchasing/downloading software and following steps suggested by the website or software. The supporter will receive the support request from a user (operation 2016). In response, the supporter will accept the request (operation 2054). The supporter then accesses the content service interface(s) (operation 2056), and uses the interface to generate content for the user (operation 2060). The content is then provided to the user through integration with the communication service (operation 2014).

In connection with the mechanisms provided by the integration with the communication service (operation 2014), the user may receive content from the supporter (operation 2066), and provide a response (or fail to provide a response) to the content (operation 2068). To encourage response to content, the supporter may provide one or more reminders to the user regarding the content and associated actions or goals (operation 2062). The user may also provide a rating of the content (operation 2070). The rating of the content, and appropriate reminders and feedback (operation 2064), may be exchanged through the integration with the communication service (operation 2014).

The supporter may be provided with feedback on a variety of environmental data values of the user (including wearable device data), provided in context to transmit meaningful data about the user to the supporter. The environmental data values may include moment-in-time data used to craft informed and relevant selections, including environmental considerations, psychological or physiological considerations, even the weather at the location of the user. Further, the supporter may be able to choose suggested content among available choices and provide guidance to the communication process (such as choosing one option among three suitable options, based on the supporter's understanding of which suggested content is most relevant or would be most well-received by the user)

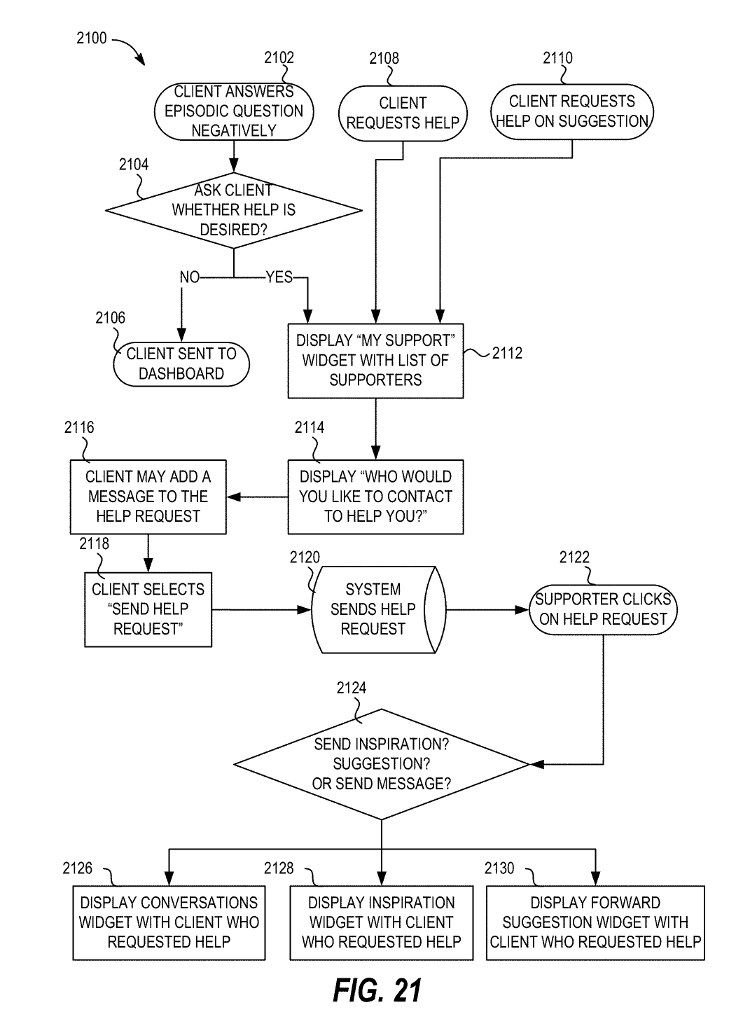

FIG. 21 illustrates a flowchart 2100 of supporter interaction with a user in a goal-based worldlow according to an example described herein. When a user answers an episodic question (e.g., a question to the human user 106 that is designed to obtain or measure the psychological state of the human user 106) negatively, such as by responding “terrible”, “not good”, or the like to an episodic question “How are you today?”, or “How did that activity feel?” (operation 2102), the application can ask the human user 106 if they would like help (operation 2104). When the human user 106 indicates that they do not want help, the human user 106 can he sent to a dashboard (operation 2106) (e.g., a dashboard providing a user interface starting point or option).

When the human user 106 indicates that they do want help, such as by answering “Yes” to the question “would you like help?” (operation 2108), requesting help using a user interface widget or requesting help on a link provided on a suggestion (operation 2110), then the human user 106 may be presented with a list of supporters. The list of supporters may be provided from list of supporters from a user supporter management widget (operation 2112). The human user 106 may be asked who they would like to contact to help them (operation 2114). When the human user 106 requests help using a link or button on a suggestion, such as an accepted suggestion, that was sent to the human user 106 from a supporter, then the human user 106 may be directed (e.g., automatically), to the supporter that sent the suggestion. The human user 106 may select one or more supporters, or groups of supporters to help. The human user 106 may add a message to a help request (operation 2116) and the help request may be sent to the respective supporter(s), such as by the human user 106 selecting a “send request” option (operation 2118). The application may send the help request (along with any messages the human user 106 added) to the selected supporters (operation 2120). The help request may be accompanied by notifications that are configured to alert the supporter, such as a text, email, or other notification, that the human user 106 is looking for help.

The supporter can click on or otherwise interact with the help request (operation 2122). The application may prompt the supporter to take an action (decision 2124) by asking if the supporter if he or she would like to send an inspirational message, suggestion, other message, or if they would like to contact the human user 106 directly. If the supporter would like to contact the human user 106 directly then a conversation box or other conversations widget can be opened for the supporter to chat with the human user 106 (operation 2126). If the supporter would like to send inspiration to the human user 106, a client inspiration widget may be accessed so that the supporter can determine what inspires the human user 106 (operation 2128). If the supporter would like to forward a suggestion produced by the information system, a supporter suggestion interaction widget or other suggestion forwarding widget may be accessed to forward suggestions from the supporter to the human user 106 (operation 2130).

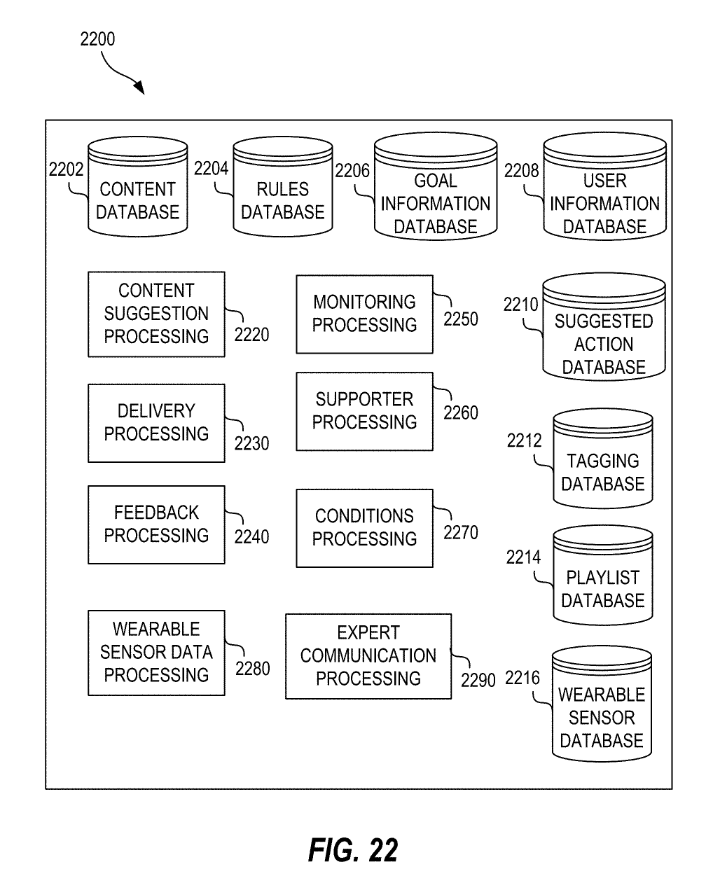

FIG. 22 illustrates an example of a system configuration of an information system 2200 configured to provide therapy activity content, in connection with the therapy activity management techniques described above. The information system 2200 may include a content database 2202, a rules database 2204, a goal information database 2206, a user information database 2208, a suggested action database 2210, a tagging database 2212, a playlist database, and a wearable sensor database 2216.

The content database 2202 may include information from external sources, such as the supporter network 110, a professional expert working in a field relevant to a goal, other databases, or a combination thereof, among others. The rules database 2204 may include rules for formatting and providing personalized suggestions (e.g., suggested actions) to the human user 106. Such rules may include timing restrictions, wording suggestions or restrictions, or suggested action restrictions (e.g., a suggestion with a certain attribute or tag should not be presented to a specific client, such as the human user 106).

The goal information database 2206 may include data relevant to getting the human user 106 to achieve a particular therapy goal. The goal information may include certain activities that are a prerequisite to achieving a therapy goal, recommended for achieving the therapy goal, fun (e.g., things to keep the human user 106 in a positive state of mind or reward the human user 106 for their hard work or achievements), or a combination thereof, among others.

The user information database 2208 may include information gained from questionnaires or learned through the human user 106 or supporters in the supporter network 110 using the system. The user information database 2208 may include information about all users of the system including supporters, clients, administrators of the system, or potential clients, among others. The suggested action database 2210 may include suggestions including pre statements, action statements, and post statements. The suggested action database 2210 may also include a record of which user has completed which suggestion, when the human user 106 completed the suggestion, or how long it has been since the system recommended that suggestion to the human user 106. The tagging database 2212 may include a record of all the tags and tagging relationships (attributes) that have been created for suggestions, playlists, or programs, and which suggestions, programs, or playlists the tag is associated with. The playlist database 2214 may include data associated with a playlist of the suggested actions, for performance of respective therapy activities by the human user. The wearable sensor database 2216 may include data obtained from respective wearable devices worn by a subject user, including raw or composite data that provides measurements for determining compliance and performance of the respective therapy activities.

While FIG. 22 shows eight separate databases 2202-2216, the information contained within the databases may be contained within any number of databases or data storage system. For example, the information in the suggested action and tagging databases 2210, 2212 may be combined into a single database, or the data for the wearable sensor database 2216 may be maintained by a third party service.

The information system 2200 may include one or more processing components (e.g., implemented in circuitry) including content suggestion processing 2220, delivery processing 2230, feedback processing 2240, monitoring processing 2250, supporter processing 2260, conditions processing 2270, wearable sensor data processing 2280, and expert communication processing 2290. The content suggestion processing 2220 may receive suggestions or have access to the suggested action database 2210, to produce actionable therapy activity content. The content suggestion processing 2220 may implement filter(s) and weight(s), such as to allow the content suggestion processing 2220 to filter, prioritize, or present suggestions of therapy activity content to the human user 106.

The delivery processing 2230 may present at least one suggestion or message to the supporter network 110 or the human user 106, such as at a certain relevant time, to encourage performance of the therapy activity. The delivery processing 2230 may be configured to modify or amend the suggestion or message that is delivered so as to be appropriate for the human user 106. Such a configuration may make the human user 106 more likely to complete the therapy activity suggestion.

The feedback processing 2240 may be configured to receive feedback about therapy activity suggestions and therapy activity statuses from a human user 106, process the feedback, and send the processed feedback to the user information database 2208, rules database 2204, content database 2202, or suggested action database 2210.

The monitoring processing 2250 may be configured to monitor a user's progress towards their therapy goal(s), a user's progress on completing a suggestion, program, therapy activity, or playlist, and may provide the delivery processing 2230 with information relevant to what messages (e.g., prompts, reminders, or encouragements) should be sent to the human user 106.

The supporter processing 2260 may be configured to provide the supporter network 110 with the ability to make suggestions for a suggestion to present to the human user 106, provide information relevant to getting the human user 106 to their therapy goal (e.g., likes, dislikes, barriers, or incentives for the human user 106, etc.), suggest messages to send to the human user 106 that may be modified by the delivery processing 2230, or suggest tags that should be associated with the human user 106.

The conditions processing 2270 may be configured to maintain relevant information from an ecosystem of conditions and the user data values or data processes 108 that are relevant to the selection and delivery of relevant content. This may include direct or derived contextual data, or data relevant to barriers and incentives. For example, the contextual information maintained in conditions processing 2270 may provide input for rules to express the conditions to deliver content to the proper user, at the proper time, in the proper context, and with the proper communication medium.

The wearable sensor data processing 2280 may be configured to process data obtained from one or more wearable devices of the human user 106, including correlating and associating the data from the wearable devices with specific therapy activities and therapy goals. For example, the data may be processed to determine whether a certain therapy activity is being performed from various raw electromechanical sensor data, to determine the associated time, frequency, and intensity of an activity from the sensor data, and to match the sensor data with a completion status of the activity and an associated therapy goal, plan, or playlist.

The expert communication processing 2290 may be configured to implement therapy activities, playlists, and plans from an expert user, such as the therapist 104 or other healthcare professional. The expert communication processing 2290 may further facilitate communications from the expert user to one or a set of users, including monitoring of the various therapy activities, playlists, and plans.

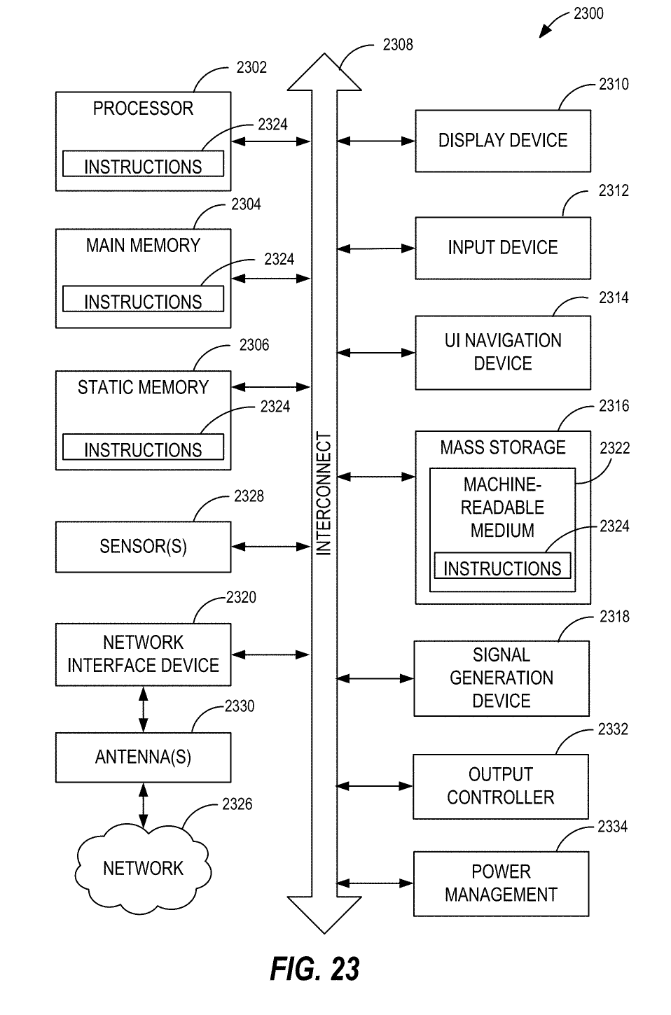

FIG. 23 is a block diagram illustrating an example computer system machine upon which any one or more of the methodologies herein discussed may be run. Computer system 2300 may be embodied as a computing device, providing operations of the suggestion engine 204, supporter network 110, health information system 102 or interface components, or any other processing or computing platform or component described or referred to herein. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The computer system machine may be a personal computer (PC) that may or may not be portable (e.g., a notebook or a netbook), a tablet, a set-top box (STB), a gaming console, a Personal Digital Assistant (PDA), a mobile telephone or smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 2300 includes a processor 2302 (e.g., a central processing unit (CPU), a graphics processing unit (GPU) or both), a main memory 2304 and a static memory 2306, which communicate with each other via an interconnect 2308 (e.g., a link, a bus, etc.). The computer system 2300 may further include a video display unit 2310, an alphanumeric input device 2312 (e.g., a keyboard), and a user interface (UI) navigation device 2314 (e.g., a mouse). In one example, the video display unit 2310, input device 2312 and UI navigation device 2314 are a touch screen display. The computer system 2300 may additionally include a storage device 2316 (e.g., a drive unit), a signal generation device 2318 (e.g., a speaker), an output controller 2332, a power management controller 2334, and a network interface device 2320 (which may include or operably communicate with one or more antennas 2330, transceivers, or other wireless communications hardware), and one or more sensors 2328, such as a GPS sensor, compass, location sensor, accelerometer, or other sensor.

The storage device 2316 includes a machine-readable medium 2322 on which is stored one or more sets of data structures and instructions 2324 (e.g., software) embodying or utilized by any one or more of the methodologies or functions described herein. The instructions 2324 may also reside, completely or at least partially, within the main memory 2304, static memory 2306, and/or within the processor 2302 during execution thereof by the computer system 2300, with the main memory 2304, static memory 2306, and the processor 2302 also constituting machine-readable media.

While the machine-readable medium 2322 is illustrated in an example to be a single medium, the term “machine-readable medium” may include a single medium or multiple media (e.g., a centralized or distributed database, and/or associated caches and servers) that store the one or more instructions 2324. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, optical media, and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 2324 may further be transmitted or received over a communications network 2326 using a transmission medium via the network interface device 2320 utilizing any one of a number of well-known transfer protocols (e.g., HTTP). Examples of communication networks include a local area network (LAN), wide area network (WAN), the Internet, mobile telephone networks, Plain Old Telephone (POTS) networks, and wireless data networks (e.g., 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Other applicable network configurations may be included within the scope of the presently described communication networks. Although examples were provided with reference to a local area wireless network configuration and a wide area Internet network connection, it will be understood that communications may also be facilitated using any number of personal area networks, LANs, and WANs, using any combination of wired or wireless transmission mediums.

The embodiments described above may be implemented in one or a combination of hardware, firmware, and software. For example, a health 1.0 information system may include or be embodied on a server running an operating system with software running thereon. While some embodiments described herein illustrate only a single machine or device, the terms “system”, “machine”, or “device” shall also be taken to include any collection of machines or devices that individually or jointly execute a set (or multiple sets) of instructions to perform any one or more of the methodologies discussed herein.

Embodiments may also be implemented as instructions stored on a computer-readable storage device or storage medium, which may be read and executed by at least one processor to perform the operations described herein. A computer-readable storage device or storage medium may include any non-transitory mechanism for storing information in a form readable by a machine (e.g., a computer). For example, a computer-readable storage device or storage medium may include read-only memory (ROM), random-access memory (RAM), magnetic disk storage media, optical storage media, flash-memory devices, and other storage devices and media. In some embodiments, the electronic devices and computing systems described herein may include one or more processors and may be configured with instructions stored on a computer-readable storage device.

Examples, as described herein, may include, or may operate on, logic or a number of components, modules, or mechanisms, such as may be embodied by structural circuitry. Such examples are intended tangible entities (e.g., hardware) capable of performing specified operations and may be configured or arranged in a certain manner. In an example, circuits may be arranged (e.g., internally or with respect to external entities such as other circuits) in a specified manner. In an example, the whole or part of one or more computer systems (e.g., a standalone, client or server computer system) or one or more hardware processors may be configured by firmware or software (e.g., instructions, an application portion, or an application) that operates to perform specified operations. In an example, the software may reside on a machine readable medium. In an example, the software, when executed by the underlying hardware, causes the hardware to perform the specified operations.

Additional examples of the presently described method, system, and device embodiments include the following, non-Limiting configurations. Each of the following nonlimiting examples can stand on its own, or can be combined in any permutation or combination with any one or more of the other examples provided below, in the claims, or elsewhere in the present disclosure.

A first example can include the subject matter (such as an apparatus, a method, a means for performing acts, or a machine readable medium including instructions that, when performed by the machine, that can cause the machine to perform acts), for implementing the presently described therapy workflows, including with use of a patient or therapist graphical user interface for the presently described therapy workflows.

A second example can include, or can optionally be combined with the subject matter of the first example, to include subject matter (such as an apparatus, a method, a means for performing acts, or a machine readable medium including instructions that, when performed by the machine, that can cause the machine to perform acts), for a health information system, including with use of an information system configured to implement the presently described therapy workflows, suggestion engine, and dynamic content selection.

A third example can include, or can optionally be combined with the subject matter of one or any combination of the first and second example, to include subject matter (such as an apparatus, a method, a means for performing acts, or a machine readable medium including instructions that, when performed by the machine, that can cause the machine to perform acts), for a health information system, configured to generate and transmit content for user interfaces including patient user interfaces, therapist user interfaces, health information system outputs, and perform related controls of personal electronic devices.

The following claims are hereby incorporated into the detailed description, with each claim and identified combination of claims standing on its own as a separate example.

What is claimed is:

1. A method for performing a therapy workflow, comprising a plurality of electronic operations executed with a processor and memory of an electronic device, the plurality of electronic operations including:
evaluating profile characteristics of a human user, the profile characteristics being associated with a physiological therapy session, and the physiological therapy session involving a plurality of therapy activities to be performed by the human user;
evaluating wearable sensor data originating from a wearable device in communication with the electronic device, the wearable device being worn by the human user, wherein the wearable device generates the wearable sensor data from monitoring activity of the human user during the physiological therapy session;
receiving therapy content to be output to the human user during the physiological therapy session, wherein the therapy content is provided from an information system to the electronic device, and wherein the therapy content is selected at least in part by a human healthcare professional to be delivered to the human user in a therapy program managed by the information system, the therapy program including the physiological therapy session; and
outputting the therapy content during the physiological therapy session, wherein the outputting of the therapy content is customized to the profile characteristics of the human user, and wherein the outputting of the therapy content is further customized based on the wearable sensor data obtained from the wearable device during the physiological therapy session.

2. The method of claim 1, further comprising:
determining a status of performance of the plurality of therapy activities by the human user during the physiological therapy session; and
generating user interface content to display with a graphical user interface in the electronic device of the human user, wherein the user interface content includes the therapy content and the status of performance of the plurality of therapy activities;
wherein outputting the therapy content includes outputting the user interface content in the graphical user interface, wherein the user interface content is updated during the physiological therapy session to indicate the status of performance of the plurality of therapy activities, based on the wearable sensor data from monitoring of the plurality of therapy activities.

3. The method of claim 2,
wherein the wearable sensor data includes mechanical or electrical measurements of the wearable device that indicate a time, frequency, range of motion, and intensity of the performance of the plurality of therapy activities, and
wherein the user interface content is updated during the physiological therapy session to provide a real-time graphical representation of the time, frequency, range of motion, and intensity of the performance of the plurality of therapy activities.

4. The method of claim 1, further comprising:
evaluating a plurality of therapy characteristics, the plurality of therapy characteristics defining respective characteristics for the plurality of therapy activities to be performed by the human user in the physiological therapy session, wherein the therapy content includes instructions for a particular therapy activity that are selected based on the plurality of therapy characteristics; and
wherein transmitting the therapy content includes delivering the therapy content to the electronic device based on a timing indicated with the plurality of therapy characteristics.

5. The method of claim 4, wherein the plurality of therapy characteristics include a quantity of the therapy activities, a quality of the therapy activities, or a frequency of the therapy activities, wherein the quantity of the therapy activities, the quality of the therapy activities, or the frequency of the therapy activities is determined from data collected from the therapy activities being performed by the human user.

6. The method of claim 1., further comprising:
evaluating a plurality of output requirements for content to be provided in the physiological therapy session, the plurality of output requirements established by the human healthcare professional for the human user;
wherein the therapy content includes instructions for a particular therapy activity that are provided based on the plurality of output requirements.

7. The method of claim 1, further comprising:
performing a plurality of objective measurements and subjective measurements during the physiological therapy session, to determine a status of the plurality of therapy activities; and
providing the plurality of objective measurements and subjective measurements as feedback to a suggestion engine of the information system, wherein the suggestion engine provides the therapy content to be output to the human user;
wherein the objective measurements include activity data measurements of the wearable device obtained during the plurality of therapy activities; and
wherein the subjective measurements include measurements of the plurality of therapy activities based on a questionnaire for the plurality of therapy activities that is provided to the human user.

8. The method of claim 1,
wherein the healthcare professional is a therapist,
wherein the plurality of therapy activities include respective physical therapy exercises established by the therapist in a therapy regimen, the therapy regimen being managed by a suggestion engine of the information system,
wherein the suggestion engine analyzes inferences for the respective physical therapy exercises represented in data for one or more of: types of the respective physical therapy exercises, external influences, environmental impacts, expected human behavior, peer pressures to the human user, and motivations, and
wherein the suggestion engine selects a type, duration, and timing of the respective physical therapy exercises based on the analyzed inferences.

9. The method of claim 8, wherein the type, duration, and timing of notifications for the respective physical therapy exercises are determined with use of an automated bot, the automated bot to control notifications for the respective physical therapy exercises according to a defined frequency and personality profile of the automated hot.

10. The method of claim 1,
wherein the profile characteristics of the human user include physiological data obtained from an electronic profile of the human user maintained by the information system, and
wherein the therapy content to be output during the physiological therapy session is customized by the information system to the electronic profile of the human user to affect one or more of: delivery timing, message content, or delivery via a supporter.

11. The method of claim 1,
wherein a type of the therapy activities is one of: physical therapy, behavior therapy, acute condition therapy, chronic condition therapy, or weight loss, and
wherein the profile characteristics of the human user include one or more of: likes data, dislikes data, psychological data, personality data, prior action or inaction data, or success data.

12. The method of claim 1,
wherein the plurality of therapy activities include respective physical therapy exercises established by the healthcare professional in a therapy regimen,
wherein a type, duration, and timing of the respective physical therapy exercises are remotely modified by the healthcare professional to provide a update to the therapy regimen for home use by the human user.

13. A non-transitory machine-readable storage medium comprising a plurality of instructions that, in response to being executed on a computing device, cause the computing device to:
evaluate profile characteristics of a human user, the profile characteristics being associated with a physiological therapy session, and the physiological therapy session involving a plurality of therapy activities to be performed by the human user;
evaluate wearable sensor data originating from a wearable device in communication with the computing device, the wearable device being worn by the human user, wherein the wearable device generates the wearable sensor data from monitoring activity during the physiological therapy session;
receive therapy content to be output to the human user during the physiological therapy session, wherein the therapy content is delivered from an information system to the computing device, and wherein the therapy content is selected at least in part by a human healthcare professional to be delivered to the human user in a therapy program managed by the information system, the therapy program including the physiological therapy session; and
output the therapy content during the physiological therapy session, wherein the outputting of the therapy content is customized to the profile. characteristics of the human user, and wherein the outputting of the therapy content is further customized based on the wearable sensor data obtained from the wearable device during the physiological therapy session.

14. The non-transitory machine-readable storage medium of claim 13, wherein the instructions also cause the computing device to perform operations that:
determine a status of performance of the plurality of therapy activities by the human user during the physiological therapy session; and
generate user interface content to display with a graphical user interface in the computing device of the human user, wherein the user interface content includes the therapy content and the status of performance of the plurality of therapy activities;
wherein the user interface content is output in the graphical user interface, and wherein the user interface content is updated during the physiological therapy session to indicate the status of performance of the plurality of therapy activities, based on the wearable sensor data from monitoring of the plurality of therapy activities.

15. The non-transitory machine-readable storage medium of claim 14,
wherein the wearable sensor data includes mechanical or electrical measurements of the wearable device that indicate a time, frequency, range of motion, and intensity of the performance of the plurality of therapy activities, and
wherein the user interface content is updated during the physiological therapy session to provide a real-time graphical representation of the time, frequency, range of motion, and intensity of the, performance of the plurality of therapy activities.

16. The non-transitory machine-readable storage medium of claim 13, wherein the instructions also cause the computing device to perform operations that:
evaluate a plurality of therapy characteristics, the plurality of therapy characteristics defining respective characteristics for the plurality of therapy activities to be performed by the human user in the physiological therapy session;
wherein the plurality of therapy characteristics include a quantity of the therapy activities, a quality of the therapy activities, or a frequency of the therapy activities, wherein the quantity of the therapy activities, the quality of the therapy activities, or the frequency of the therapy activities is determined from data collected from the therapy activities being performed by the human user;
wherein the therapy content includes instructions for a particular therapy activity that are selected based on the plurality of therapy characteristics; and
wherein the operations that transmit the therapy content includes delivering the therapy content to the computing device based on a timing indicated with the plurality of therapy characteristics.

17. The non-transitory machine-readable storage medium of claim 13, wherein the instructions also cause the computing device to perform operations that:
evaluate a plurality of output requirements for content to be provided in the physiological therapy session, the plurality of output requirements established by the human healthcare professional for the human user, wherein the therapy content includes instructions for a particular therapy activity that are provided based on the plurality of output requirements.

18. The non-transitory machine-readable storage medium of claim 13, wherein the instructions also cause the computing device to perform operations that:
perform a plurality of objective measurements and subjective measurements during the physiological therapy session, to determine a status of the plurality of therapy activities; and
transmit the plurality of objective measurements and subjective measurements to a suggestion engine of the information system, wherein the suggestion engine provides the therapy content to be output to the human user;
wherein the objective measurements include activity data measurements of the wearable device obtained during the plurality of therapy activities; and
wherein the subjective measurements include measurements of the plurality of therapy activities based on a questionnaire for the plurality of therapy activities that is provided to the human user.

19. The non-transitory machine-readable storage medium of claim 13,
wherein the healthcare professional is a therapist,
wherein the plurality of therapy activities include respective physical therapy exercises established by the therapist in a therapy regimen, the therapy regimen being managed by a suggestion engine of the information system,
wherein the suggestion engine analyzes inferences for the respective physical therapy exercises represented in data for one or more of: types of the respective physical therapy exercises, external influences, environmental impacts, expected human behavior, peer pressures to the human user, and motivations,
wherein the suggestion engine selects a type, duration, and timing of the respective physical therapy exercises based on the analyzed inferences, and
wherein the type, duration, and timing of notifications for the respective physical therapy exercises are determined with use of an automated bot, the automated bot to control notifications for the respective physical therapy exercises according to a defined frequency and personality profile of the automated hot.

20. The non-transitory machine-readable storage medium of claim 13,
wherein the profile characteristics of the human user include physiological data obtained from an electronic profile of the human user maintained by the information system,
wherein the therapy content to be output during the physiological therapy session is customized by the information system to the electronic profile of the human user based on one or more of: delivery timing, message content, or supporter delivery,
wherein a type of the therapy activities is one of: physical therapy, behavior therapy, acute condition therapy, chronic condition therapy, or weight loss, and
wherein the profile characteristics of the human user include one or more of: likes data, dislikes data, psychological data, personality data, prior action or inaction data, or success data.

21. A computing device, comprising:
a hardware processor; and
a memory device comprising instructions stored thereon, which when executed by the hardware processor, configure the hardware processor to perform electronic operations with a user interface of the computing device that: evaluate profile characteristics of a human user, the profile characteristics being associated with a physiological therapy session, and the physiological therapy session involving a plurality of therapy activities to be performed by the human user;
evaluate wearable sensor data originating from a wearable device in communication with the computing device, the wearable device being worn by the human user, wherein the wearable device generates the wearable sensor data from monitoring activity during the, physiological therapy session;
receive therapy content to be output to the human user during the physiological therapy session, wherein the therapy content is delivered from an information system to the computing device, and wherein the therapy content is selected at least in part by a human therapist to be delivered to the human user in a therapy program managed by the information system, the therapy program including the physiological therapy session; and
output the therapy content during the, physiological therapy session, wherein the outputting of the therapy content is customized to the profile characteristics of the human user, and wherein the outputting of the therapy content is further customized based on the wearable sensor data obtained from the wearable device during the physiological therapy session.

22. The computing device of claim 21, the instructions further to configure the hardware processor to perform electronic operations that:
determine a status of performance of the plurality of therapy activities by the human user during the physiological therapy session; and
generate user interface content to display with a graphical user interface in the computing device, wherein the user interface content includes the therapy content and the status of performance of the plurality of therapy activities;
wherein the user interface content is output in the graphical user interface, and wherein the user interface content is updated during the physiological therapy session to indicate the status of performance of the plurality of therapy activities, based on the wearable sensor data from monitoring of the plurality of therapy activities.

23. The computing device of claim 22,
wherein the wearable sensor data includes mechanical or electrical measurements of the wearable device that indicate a time, frequency, range of motion, and intensity of the performance of the plurality of therapy activities, and
wherein the user interface content is updated during the physiological therapy session to provide a real-time graphical representation of the time, frequency, range of motion, and intensity of the performance of the plurality of therapy activities.

24. The computing device of claim 21,
wherein the plurality of therapy activities include respective physical therapy exercises established by the human therapist in a therapy regimen, the therapy regimen being managed by a suggestion engine of the information system,
wherein the suggestion engine analyzes inferences for the respective physical therapy exercises represented in data for one or more of: types of the respective physical therapy exercises, external influences, environmental impacts, expected human behavior, peer pressures to the human user, and motivations, and
wherein the suggestion engine selects a type, duration, and timing of the respective physical therapy exercises based on the analyzed inferences.
